(19) United States
(12) Patent Application Publication
(10) Pub. No.: US 2026/0074854 A1
(43) Pub. Date: Mar. 12, 2026

(54) DYNAMIC REFERENCE SIGNAL SIGNALING

(71) Applicant: QUALCOMM Incorporated, San Diego, CA (US)

(72) Inventors: Chih-Hao LIU, San Diego, CA (US); Jing SUN, San Diego, CA (US); Jing JIANG, San Diego, CA (US)

(21) Appl. No.: 18/884,066

(22) Filed: Sep. 12, 2024

(51) Int. Cl. H04L 5/00; H04W 72/044; H04W 72/231

(52) U.S. Cl. CPC H04L 5/0048; H04W 72/044; H04W 72/231

(57) ABSTRACT

Methods, systems, and devices for wireless communications are described. A first wireless device and a second wireless device may coordinate the presence of a reference signal in one or more symbols of a slot, where the reference signal is associated with phase measurements across a phase jump boundary of the slot. In some aspects, the first wireless device may receive control information that triggers the transmission of the reference signal in the one or more symbols of the slot, where the control information may further indicate the position of the one or more symbols within the slot. In such aspects, the one or more symbols associated with the reference signal may be prior to the phase jump boundary, after the phase jump boundary, or a combination of both. As such, the first wireless device may monitor the one or more symbols, receive the reference signal, and perform the phase measurements.

### FIELD OF TECHNOLOGY

The following relates to wireless communications, including dynamic reference signal signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Aspects of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The present disclosure relates to methods, systems, devices, and apparatuses for dynamic reference signal signaling.

A method for wireless communications implemented by a first wireless device is described. The method may include receiving, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary, monitoring the one or more symbols for the reference signal in accordance with the control information, and performing the phase measurements associated with the phase jump boundary using the reference signal in accordance with the monitoring of the one or more symbols.

A first wireless device for wireless communications implemented is described. The first wireless device may include one or more memories storing processor executable code, and one or more processors coupled with the one or more memories. The one or more processors may individually or collectively be operable to execute the code to cause the one or more processors to receive, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary, monitor the one or more symbols for the reference signal in accordance with the control information, and perform the phase measurements associated with the phase jump boundary using the reference signal in accordance with the monitoring of the one or more symbols.

Another first wireless device for wireless communications implemented is described. The first wireless device may include means for receiving, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary, means for monitoring the one or more symbols for the reference signal in accordance with the control information, and means for performing the phase measurements associated with the phase jump boundary using the reference signal in accordance with the monitoring of the one or more symbols.

A non-transitory computer-readable medium storing code for wireless communications implemented is described. The code may include instructions executable by one or more processors to receive, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary, monitor the one or more symbols for the reference signal in accordance with the control information, and perform the phase measurements associated with the phase jump boundary using the reference signal in accordance with the monitoring of the one or more symbols.

Some examples of the method, first wireless devices, and non-transitory computer-readable medium described herein may further include operations, features, means, or instructions for communicating, with the second wireless device, first control signaling to identify the phase jump boundary associated with the first slot, where the receiving of the control information may be in accordance with the communicating of the first control signaling with the second wireless device.

Some examples of the method, first wireless devices, and non-transitory computer-readable medium described herein may further include operations, features, means, or instructions for receiving second control signaling allocating the one or more symbols in accordance with the identified phase jump boundary, where the receiving of the control information that triggers the transmission of the reference signal may be in accordance with the second control signaling.

In some examples of the method, first wireless devices, and non-transitory computer-readable medium described herein, the control information further indicates one or more symbol offsets from a first symbol associated with reception of the control information, and each of the one or more symbols may be identified in accordance with a respective symbol offset of the one or more symbol offsets.

Some examples of the method, first wireless devices, and non-transitory computer-readable medium described herein may further include operations, features, means, or instructions for receiving second control information indicating one or more symbol offsets from a first symbol associated with reception of the second control information, where each of the one or more symbols may be identified in accordance with a respective symbol offset of the one or more symbol offsets.

Some examples of the method, first wireless devices, and non-transitory computer-readable medium described herein may further include operations, features, means, or instructions for receiving radio resource control (RRC) signaling indicating a frequency density associated with the reference signal, a time density associated with the reference signal, or both, where the monitoring for the reference signal may be in accordance with the RRC signaling.

In some examples of the method, first wireless devices, and non-transitory computer-readable medium described herein, the reference signal may be received in a symbol that precedes the phase jump boundary in accordance with a prediction that the phase jump boundary may be to occur at an end of the first slot, in accordance with a prediction of demodulation reference signal (DMRS) combining between the first slot and a second slot after the first slot, or both.

In some examples of the method, first wireless devices, and non-transitory computer-readable medium described herein, the control information may be received at a start of the first slot in accordance with the phase jump boundary being between the start of the first slot and an end of a second slot that precedes the first slot, in accordance with DMRS combining between the first slot and the second slot, or both.

Some examples of the method, first wireless devices, and non-transitory computer-readable medium described herein may further include operations, features, means, or instructions for receiving RRC signaling indicating a set of multiple time domain patterns associated with the transmission of the reference signal, where the control information includes an index indicating a first time domain pattern of the set of multiple time domain patterns, and where the one or more symbols may be identified in accordance with the first time domain pattern.

In some examples of the method, first wireless devices, and non-transitory computer-readable medium described herein, the control information schedules a shared data channel in the first slot.

In some examples of the method, first wireless devices, and non-transitory computer-readable medium described herein, the control information schedules a first shared data channel in a second slot that precedes the first slot in time, and the one or more symbols for the transmission of the reference signal may be associated with a second shared data channel in the first slot.

In some examples of the method, first wireless devices, and non-transitory computer-readable medium described herein, the control information indicates one or more time offsets from reception of the control information and each symbol of the one or more symbols may be identified in accordance with a respective time offset of the one or more time offsets.

In some examples of the method, first wireless devices, and non-transitory computer-readable medium described herein, the control information indicates one or more slot offsets from the first slot, one or more symbol offsets from the first slot, or both and each symbol of the one or more symbols may be identified in accordance with a respective slot offset of the one or more slot offsets, a respective symbol offset of the one or more symbol offsets, or both.

In some examples of the method, first wireless devices, and non-transitory computer-readable medium described herein, the first wireless device includes a user equipment (UE) and the second wireless device includes a network entity, the first wireless device includes the network entity and the second wireless device includes the UE, or the first wireless device includes a first UE and the second wireless device includes a second UE.

A method for wireless communications implemented by a first wireless device is described. The method may include transmitting, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary, transmitting, via the one or more symbols, the reference signal in accordance with the control information, and communicating with the second wireless device in accordance with the transmitting of the reference signal via the one or more symbols and the phase measurements associated with the phase jump boundary.

A first wireless device for wireless communications implemented is described. The first wireless device may include one or more memories storing processor executable code, and one or more processors coupled with the one or more memories. The one or more processors may individually or collectively be operable to execute the code to cause the one or more processors to transmit, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary, transmit, via the one or more symbols, the reference signal in accordance with the control information, and communicate with the second wireless device in accordance with the transmitting of the reference signal via the one or more symbols and the phase measurements associated with the phase jump boundary.

Another first wireless device for wireless communications implemented is described. The first wireless device may include means for transmitting, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary, means for transmitting, via the one or more symbols, the reference signal in accordance with the control information, and means for communicating with the second wireless device in accordance with the transmitting of the reference signal via the one or more symbols and the phase measurements associated with the phase jump boundary.

A non-transitory computer-readable medium storing code for wireless communications implemented is described. The code may include instructions executable by one or more processors to transmit, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary, transmit, via the one or more symbols, the reference signal in accordance with the control information, and communicate with the second wireless device in accordance with the transmitting of the reference signal via the one or more symbols and the phase measurements associated with the phase jump boundary.

Some examples of the method, first wireless devices, and non-transitory computer-readable medium described herein may further include operations, features, means, or instructions for communicating, with the second wireless device, first control signaling to identify the phase jump boundary associated with the first slot, where the transmitting of the control information may be in accordance with the communicating of the first control signaling with the second wireless device.

Some examples of the method, first wireless devices, and non-transitory computer-readable medium described herein may further include operations, features, means, or instructions for transmitting second control signaling allocating the one or more symbols in accordance with the identified phase jump boundary associated with the first slot, where the transmitting the control information triggering the transmission of the reference signal may be in accordance with the second control signaling.

In some examples of the method, first wireless devices, and non-transitory computer-readable medium described herein, the control information further indicates one or more symbol offsets from a first symbol associated with the transmitting of the control information, and each of the one or more symbols may be identified in accordance with a respective symbol offset of the one or more symbol offsets.

Some examples of the method, first wireless devices, and non-transitory computer-readable medium described herein may further include operations, features, means, or instructions for transmitting second control information indicating one or more symbol offsets from a first symbol associated with the transmitting of the second control information, where each symbol of the one or more symbols may be identified in accordance with a respective symbol offset of the one or more symbol offsets.

Some examples of the method, first wireless devices, and non-transitory computer-readable medium described herein may further include operations, features, means, or instructions for transmitting RRC signaling indicating a frequency density associated with the reference signal, a time density associated with the reference signal, or both, where the transmitting of the reference signal may be in accordance with receiving the RRC signaling.

In some examples of the method, first wireless devices, and non-transitory computer-readable medium described herein, the reference signal may be transmitted in a symbol that precedes the phase jump boundary in accordance with a prediction that the phase jump boundary may be to occur at an end of the first slot, in accordance with a prediction of DMRS combining between the first slot and a second slot after the first slot, or both.

In some examples of the method, first wireless devices, and non-transitory computer-readable medium described herein, the control information may be transmitted at a start of the first slot in accordance with the phase jump boundary being between the start of the first slot and an end of a second slot that precedes the first slot, in accordance with DMRS combining between the first slot and the second slot, or both.

Some examples of the method, first wireless devices, and non-transitory computer-readable medium described herein may further include operations, features, means, or instructions for transmitting RRC signaling indicating a set of multiple time domain patterns associated with the transmission of the reference signal, where the control information includes an index indicating a first time domain pattern of the set of multiple time domain patterns, and where the one or more symbols may be identified in accordance with the first time domain pattern.

In some examples of the method, first wireless devices, and non-transitory computer-readable medium described herein, the control information schedules a shared data channel in the first slot.

In some examples of the method, first wireless devices, and non-transitory computer-readable medium described herein, the control information schedules a first shared data channel in a slot that precedes the first slot in time, and the one or more symbols for the transmission of the reference signal may be associated with a second shared data channel in the first slot.

In some examples of the method, first wireless devices, and non-transitory computer-readable medium described herein, the control information indicates one or more time offsets from reception of the control information and each symbol of the one or more symbols may be identified in accordance with a respective time offset of the one or more time offsets.

In some examples of the method, first wireless devices, and non-transitory computer-readable medium described herein, the control information indicates one or more slot offsets from the first slot, one or more symbol offsets from the first slot, or both and each symbol of the one or more symbols may be identified in accordance with a respective slot offset of the one or more slot offsets, a respective symbol offset of the one or more symbol offsets, or both.

In some examples of the method, first wireless devices, and non-transitory computer-readable medium described herein, the first wireless device includes a UE and the second wireless device includes a network entity, the first wireless device includes the network entity and the second wireless device includes the UE, or the first wireless device includes a first UE and the second wireless device includes a second UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an aspect of a wireless communications system that supports dynamic reference signal signaling in accordance with one or more aspects of the present disclosure.

FIG. 2 shows an aspect of a wireless communications system that supports dynamic reference signal signaling in accordance with one or more aspects of the present disclosure.

FIGS. 3A and 3B show aspects of resource diagrams that support dynamic reference signal signaling in accordance with one or more aspects of the present disclosure.

FIG. 4 shows an aspect of a resource diagram that supports dynamic reference signal signaling in accordance with one or more aspects of the present disclosure.

FIG. 5 shows an aspect of a process flow that supports dynamic reference signal signaling in accordance with one or more aspects of the present disclosure.

FIGS. 6 and 7 show block diagrams of devices that support dynamic reference signal signaling in accordance with one or more aspects of the present disclosure.

FIG. 8 shows a block diagram of a communications manager that supports dynamic reference signal signaling in accordance with one or more aspects of the present disclosure.

FIG. 9 shows a diagram of a system including a device that supports dynamic reference signal signaling in accordance with one or more aspects of the present disclosure.

FIGS. 10 and 11 show block diagrams of devices that support dynamic reference signal signaling in accordance with one or more aspects of the present disclosure.

FIG. 12 shows a block diagram of a communications manager that supports dynamic reference signal signaling in accordance with one or more aspects of the present disclosure.

FIG. 13 shows a diagram of a system including a device that supports dynamic reference signal signaling in accordance with one or more aspects of the present disclosure.

FIGS. 14 through 17 show flowcharts illustrating methods that support dynamic reference signal signaling in accordance with one or more aspects of the present disclosure.

### DETAILED DESCRIPTION

Some wireless devices operating in a wireless communications system may experience phase discontinuity during communications. That is, a phase jump boundary (e.g., a logical or physical gap where phase continuity is not maintained) may be present within time resources (e.g., slots) allocated for communications between a receiving wireless device and a transmitting wireless device, where the phase jump boundary may be present due to radio frequency reconfigurations at either the receiving or transmitting wireless device, be present at a boundary between two slots, among other cases. Such phase jump boundaries may reduce the phase continuity during communications, leading to inaccurate channel estimations at the receiving wireless device, thereby degrading communications.

To remedy such phase discontinuities, the transmitting wireless device may transmit a glue reference signal around (e.g., before or after) the phase jump boundaries, such that the receiving wireless device may estimate the phase jump (e.g., estimate the change in phase at the phase jump boundary) across the phase jump boundaries and perform channel estimations. In some cases, the transmitting wireless device may transmit the glue reference signals statically (e.g., always on transmission), in which the transmitting wireless device transmits the glue reference signal in each of the configured candidate resources (e.g., symbols and resource elements (REs)) regardless of whether a phase jump boundary is present within the time resources. That is, by transmitting the glue reference signal statically, the transmitting wireless device may transmit the glue reference signal even in cases when no phase jump boundaries are present within the time resources, which may lead to an increase in overhead during communications between the transmitting and the receiving wireless devices.

The techniques, methods, and devices described herein may enable the wireless devices to support dynamic triggering of the glue reference signals, which may reduce the overhead associated with static transmission of glue reference signals, while also maintaining phase continuity at the receiving wireless device. In some aspects, the receiving wireless device may receive control information (e.g., downlink control information (DCI), uplink control information (UCI), or sidelink control information (SCI)) that triggers the transmission of the glue reference signal in one or more symbols of a slot. In response to receiving the control informaiton, the receiving wireless device may monitor the one or more symbols to receive the glue reference signal and perform the phase estimations. In some aspects, to facilitate the communication of the glue reference signal, the transmitting wireless device and the receiving wireless device may communicate to identify the positions of potential phase jump boundaries, such that the transmitting wireless device may dynamically allocate and trigger the transmission of the glue reference signals around the phase jump boundaries.

By dynamically triggering the transmission of the glue reference signal via the control information, the wireless devices may reduce overhead during communications by avoiding the transmission of the glue reference signal in cases where phase jump boundaries are not present. Additionally, by identifying the positions of potential phase jump boundaries, the transmitting wireless device may dynamically trigger the transmission of the glue reference signal according to the identified positions, which may increase coordination between devices, reduce signaling overhead, among other advantages.

Aspects of the disclosure are initially described in the context of wireless communications systems. Aspects of the disclosure are further described in the context of resource diagrams and process flows. Aspects of the disclosure are further illustrated by and described with reference to apparatus diagrams, system diagrams, and flowcharts that relate to dynamic reference signal signaling.

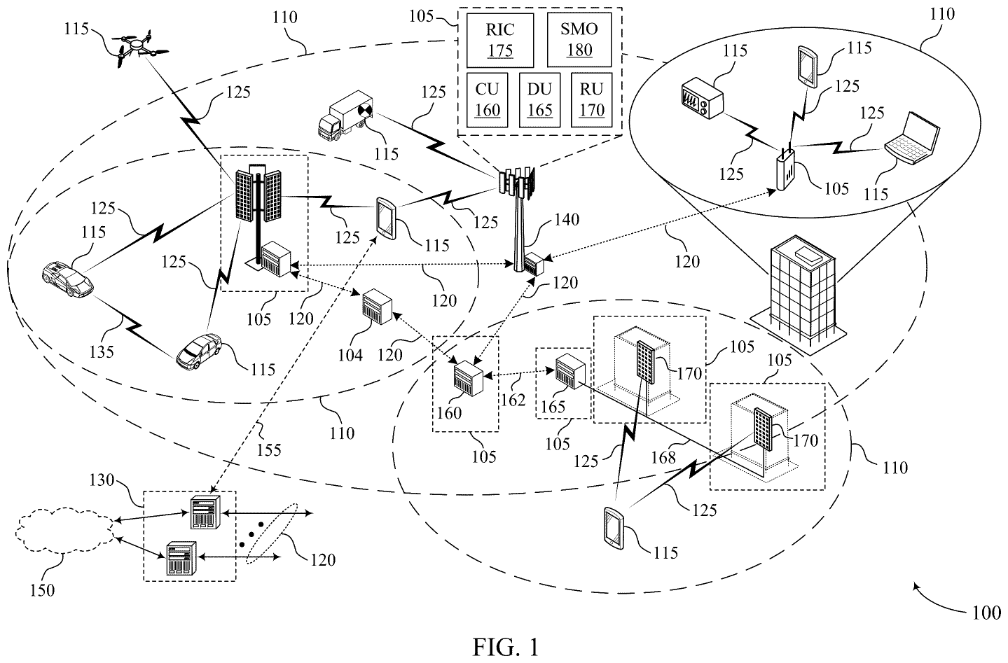

FIG. 1 shows an aspect of a wireless communications system 100 that supports dynamic reference signal signaling in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various aspects, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). A network entity 105 may support a coverage area 110 (e.g., a geographic coverage area) over which the UEs 115 and the network entity 105 may establish the communication link(s) 125. The coverage area 110 may be an aspect of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some aspects of UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. A node may be a UE 115. As another aspect, a node may be a network entity 105. As another aspect, a first node may be configured to communicate with a second node or a third node. In one aspect, the first node may be a UE 115, the second node may be a network entity 105, and the third node may be a UE 115. In another aspect, the first node may be a UE 115, the second node may be a network entity 105, and the third node may be a network entity 105. In yet other aspects, the first, second, and third nodes may be different relative to these aspects. Similarly, reference to a UE 115, network entity 105, apparatus, device, computing system, or the like may include disclosure of the UE 115, network entity 105, apparatus, device, computing system, or the like being a node. As such, disclosure that a UE 115 is configured to receive information from a network entity 105 also discloses that a first node is configured to receive information from a second node.

In some aspects, network entities 105 may communicate with a core network 130, or with one another, or both. In such aspects, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other aspects or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). In such aspects, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. In such aspects, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support dynamic reference signal signaling as described herein. Some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other aspects. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other aspects, which may be implemented in various objects such as appliances, vehicles, or meters, among other aspects.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other aspects, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. In such aspects, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. In such aspects, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. In such aspects, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other aspects, overlapping coverage areas, such as a coverage area 110, associated with different technologies may be supported by different network entities (e.g., the network entities 105). The wireless communications system 100 may include a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. In such aspects, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other aspects, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. In such aspects, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other aspects.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. In such aspects, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless devices (e.g., UEs 115 and network entities 105) operating in a wireless communications system may experience phase discontinuity during communications. That is, a phase jump boundary (e.g., a logical or physical gap where phase continuity is not maintained) may be present within time resources (e.g., slots) allocated for communications between a receiving wireless device and a transmitting wireless device, where the phase jump boundary may be present due to radio frequency reconfigurations at either the receiving or transmitting wireless device, be present at a boundary between two slots, among other cases. Such phase jump boundaries may reduce the phase continuity during communications, leading to inaccurate channel estimations at the receiving wireless device, thereby degrading communications.

To remedy such phase discontinuities, the transmitting wireless device may transmit a glue reference signal around (e.g., before or after) the phase jump boundaries, such that the receiving wireless device may estimate the phase jump (e.g., estimate the change in phase at the phase jump boundary) and perform channel estimations. In some cases, the transmitting wireless device may transmit the glue reference signals statically (e.g., always on transmission), in which the transmitting wireless device transmits the glue reference signal in each of the configured candidate resources (e.g., symbols and REs) regardless of whether a phase jump boundary is present within the time resources. That is, by transmitting the glue reference signal statically, the transmitting wireless device may transmit the glue reference signal even in cases when no phase jump boundaries are present within the time resources, which may lead to an increase in overhead during communications between the transmitting and the receiving wireless devices.

The techniques, methods, and devices described herein may enable the wireless devices to support dynamic triggering of the glue reference signals, which may reduce the overhead associated with static glue reference signals, while also maintaining phase continuity at the receiving device. In some aspects, the receiving wireless device may receive control information (e.g., DCI, UCI, SCI) that triggers the transmission of the glue reference signal in one or more symbols of a slot. In response to receiving the control informaiton, the receiving wireless device may monitor the one or more symbols to receive the glue reference signal and perform the phase estimations. In some aspects, to facilitate the communication of the glue reference signal, the transmitting wireless device and the receiving wireless device may communicate to identify the positions of potential phase jump boundaries, such that the transmitting wireless device may dynamically allocate and trigger the transmission of the glue reference signals around the phase jump boundaries.

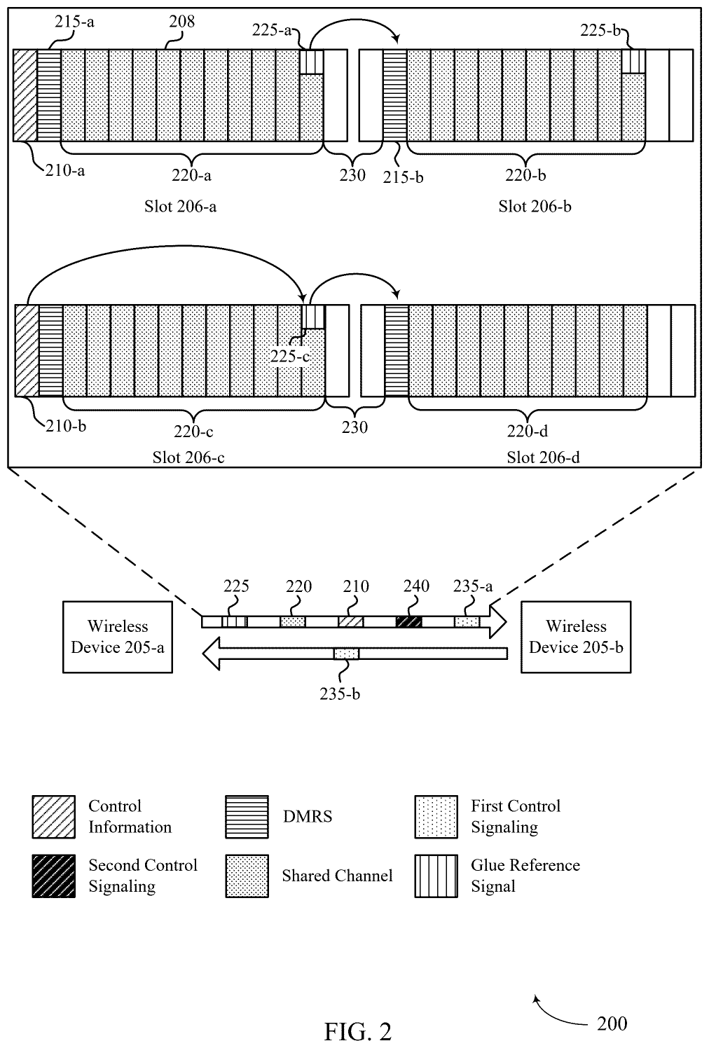

FIG. 2 shows an aspect of a wireless communications system 200 that supports dynamic reference signal signaling in accordance with one or more aspects of the present disclosure. Aspects of the wireless communications system 200 may implement, or be implemented by, aspects of the wireless communications system 100, as described herein with reference to FIG. 1. In some aspects, the wireless device 205-a may be a UE 115 or a network entity 105, while the wireless device 205-b may be a UE 115 or a network entity 105. The techniques described in the context of the wireless communications system 200 may enable the wireless devices 205 to dynamically trigger the communication of glue reference signals 225.

In some cases, the wireless devices 205 may communicate data via shared channels 220 (e.g., physical uplink shared channels (PUSCHs), physical downlink shared channels (PDSCHs), physical sidelink shared channels (PSSCHs)), where the shared channel 220 may occupy (e.g., be transmitted via) one or more symbols 208 within a slot 206. In such cases, for repeated shared channel transmissions (e.g., PUSCH transmissions), multiple segments of back-to-back symbols 208 may be utilized to extend coverage (e.g., PUSCH coverage), where such repetitions of the shared channel 220 may have different redundancy values and each repetition of the shared channel 220 may not cross boundaries between slots 206.

In some cases, the wireless devices 205 may support a fluid start length indicator value (SLIV) (e.g., a long SLIV) design, which may enable the wireless devices to communicate the shared channel 220 across slot boundaries. That is, in some wireless systems, the wireless devices 205 may allocate, via a SLIV, up to 14 symbols 208 of a slot 206 for the communication of a shared channel 220. In the fluid SLIV design, however, the wireless devices 205 may support a slot 206 with greater than 14 symbols 208, where such fluid SLIVs may avoid complicated designs to extend coverage, include demodulation reference signal (DMRS) overhead reduction by applying a more uniform time domain DMRS pattern based on the Doppler affect experienced by the wireless devices, among other factors. In this way, using the fluid SLIV design, the wireless devices 205 may communicate an increased quantity of data (or repetitions) of the shared channel 220 via a single slot 206.

As described herein, to support the fluid SLIV design and reduce time domain density of DMRSs 215, the wireless devices 205 may utilize a group of DMRS symbols within a time span (e.g., a channel estimation window) to interpolate the channel, where the size of the channel estimating window for DMRS bundling may be based on a buffer constraint at the wireless devices 205 (e.g., the UE or receiving device). In such cases, the wireless devices 205 may allocate the symbols 208 for the DMRSs 215 such that the DMRSs 215 are uniformly distributed over a duration, thereby minimizing overhead.

Such uniform distribution of DMRSs may also be utilized across different slots 206 (e.g., different SLIVs) to support extended coverage of shared channels 220. By utilizing multiple slots 206 (e.g., SLIVs) for the communication of the shared channel 220, the wireless devices 205 may schedule resources dynamically (e.g., in real time or on the fly), while the fluid SLIV design may lead to a pre-committed schedule. That is, the wireless device 205-a (e.g., a transmitting device, network entity 105, UE 115) may schedule the wireless device 205-b (e.g., receiving device or UE 115) with back-to-back slots 206, such as the slot 206-a and the slot 206-b, and indicate the use of the same precoder for transmission of the shared channels 220-a and 220-b in the case of bursty traffic. In such cases, the wireless device 205-a may not change precoders between the transmission of the shared channel 220-a and the transmission of the shared channel 220-b based on the low duty cycle sounding reference signal (SRS) transmissions or channel state information (CSI) reports.

As such, if the wireless device 205-a allocates back-to-back slots 206 for transmission of shared channels 220-a and 220-b to the wireless device 205-b, the wireless device 205-b may exploit the DMRSs 215 in adjacent slots 206 (e.g., SLIVs) jointly to further improve DMRS overhead and performance. That is, the wireless devices 205 may support DMRS sharing across multiple slots 206 (e.g., SLIVs). In such cases, such as for downlink shared channels 220 (e.g., PDSCHs), the wireless device 205-a may allocate, via the control information 210-a, a DMRS 215-a in the slot 206-a and also allocate a DMRS 215-b for the slot 206-b and may instruct the wireless device 205-b to perform cross-slot combining of the DMRSs 215 (e.g., utilize the measurements from the DMRS 215-a and DMRS 215-b to receive and decode the shared channels 220), such that DMRS overhead may be reduced. In this way, the wireless device 205-b may perform DMRS sharing across the slots 206-a and 205-b. Such operations may be utilized for both intra-UE sharing and inter-UE sharing.

In both DMRS sharing and fluid SLIV allocations, however, the wireless devices 205 may experience phase discontinuity, which may lead to inaccurate channel estimations at the wireless device 205-b, thereby degrading communications. In the case of DMRS sharing across multiple slots 206, the wireless devices 205 may experience a phase jump boundary 230 at a boundary between the slot 206-a and the slot 206-b, which may lead to phase discontinuity in the communication of the shared channels 220. Similarly, in fluid SLIV designs (e.g., a single slot 206 with greater than 14 symbols), the wireless devices 205 may experience one or more phase jump boundaries 230 between one or more symbols 208 of the slot 206 due to radio frequency reconfigurations at modems of the wireless devices 205, among other factors.

As such, to enable the wireless device 205-b (e.g., receiving device) to estimate phase jumps and perform accurate channel estimations around phase jump boundaries 230, the wireless device 205-a may transmit one or more glue reference signals 225 around the potential phase jump boundaries 230. As described herein, a phase jump boundary may be a logical (e.g., phase change due to reconfigurations or factors occurring at the wireless devices) or a physical gap (e.g., a boundary of slot between time or frequency resources) in which a phase jump (e.g., change in phase), a phase gain, or a phase state change may occur.

As an illustrative aspect, the wireless device 205-a may transmit, in a symbol 208 prior to the phase jump boundary 230 between the slot 206-a and the slot 206-b, a glue reference signal 225-a, such that the wireless device 205-b may perform a first phase estimation using the flue reference signal 225-a. The wireless device 205-b may receive the DMRS 215-b and perform a second phase estimation using the DMRS 215-b. Using both the first and second phase estimations, the wireless device 205-b may estimate the phase jump (e.g., change in phase or phase gain) across the phase jump boundary 230 and perform the joint channel estimations. In this way, the wireless device 205-b may accurately perform the joint channel estimations using both phase estimations, which may improve communications between the wireless device 205-a and the wireless device 205-b.

In some cases, the wireless device 205-a may transmit the glue reference signals 225 statically, in which the wireless device 205-a transmits the glue reference signal 225 in each of the allocated candidate resources. As an illustrative aspect, the candidate resources for the glue reference signal 225 may include at least one symbol 208 within each slot 206. Accordingly, the wireless device 205-a may transmit the glue reference signal 225-a in the symbol 208 of the slot 206-a and transmit the glue reference signal 225-b in a symbol 208 of the slot 206-b. In such cases, however, because the wireless device 205-a transmits the glue reference signal 225 in each of the candidate resources, the wireless devices 205 may experience increased overhead (e.g., such as 0.15% overhead) during communications.

That is, because the phase jump boundaries 230 may be dynamic (based on operations at the wireless devices 205), the wireless device 205-a may transmit the glue reference signals 225 even in cases when no phase jump boundaries 230 are present in (or between) the slots 206, which may further lead to an increase in overhead during communications between the wireless devices 205. As illustrated, the wireless device 205-a may transmit the glue reference signal 225-b even though the end of the slot 206-b is the end of the data burst (e.g., the share channel 220) and may not include a phase jump boundary 230, thereby leading to increased overhead in the communications.

In accordance with the techniques described herein, the wireless devices 205 may support dynamic triggering of the glue reference signals 225 to reduce signaling overhead during communications, while also maintaining phase continuity across phase jump boundaries 230. That is, if the wireless device 205-a (e.g., transmitting device) has an indication of the positions of the phase jump boundaries 230 within a slot 206 (in the case of a fluid SLIV design) or between slots 206 (in the case of DMRS sharing), the wireless devices 205 may reduce overhead by implementing a dynamic glue reference signal 225 trigger, thereby allowing the wireless device 205-b (e.g., receiver) to utilize the glue reference signal 225 and perform correct shared channel puncturing around the resources allocated for the glue reference signal 225.

In some aspects, the wireless device 205-a may dynamically indicate the presence of the glue reference signal 225 around the phase jump boundary 230. To support such dynamic indications, the wireless device 205-a and the wireless device 205-b may coordinate the location (in time) of the potential phase jump boundaries 230 (e.g., both logical and physical). In some aspects, the wireless device 205-a and the wireless device 205-b may communicate first control signaling 235 (e.g., layer 2 signaling or RRC signaling) to identify the potential phase jump boundaries 230. In such aspects, the wireless device 205-b may transmit first control signaling 235-a indicating one or more locations (in time) of potential phase jump boundaries 230 based on operations at the wireless device 205-b, such as reconfigurations at a modem of the wireless device 205-b, among others. Similarly, the wireless device 205-a may transmit first control signaling 235-b indicating one or more locations (in time) of potential phase jump boundaries based on operations at the wireless device 205-a, such as reconfigurations at a modem of the wireless device 205-a, among others.

In response to identifying the potential phase jump boundaries 230, the wireless device 205-a may configure the underlying candidate resources (e.g., REs and symbols 208) for the glue reference signal 225 around the identified phase jump boundaries 230. In some aspects, such as fluid SLIV allocations, the wireless device 205-a may configure at least a first glue reference resource signal resource (e.g., symbol and one or more REs) prior to a respective phase jump boundary 230 and configure a second glue reference signal resource signal (e.g., symbol and one or more REs) after the respective phase jump boundary 230. That is, the wireless device 205-a may allocate one or more symbols, one or more REs, or both for the transmission one or more glue reference signals 225 based on identifying the potential phase jump boundaries. The wireless device 205-a may transmit second control signaling 240 (e.g., layer 2 or RRC signaling) allocating the one or more symbols, the one or more REs, or both for the transmission of the one or more glue reference signals 225.

In some aspects, the wireless device 205-a may determine whether to transmit the glue reference signals 225 via the configured resources based on a possibility (e.g., likelihood or probability) of the phase jump boundaries 230 occurring within the resources (e.g., symbols 208 and REs) allocated for the shared channels 220, where the wireless device 205-a may trigger (e.g., signal) whether or not the glue reference signal 225 is to be transmitted in the configured resources via the control information 210-b (e.g., DCI, UCI, SCI). In this way, the wireless device 205-a may configure the candidate resources for the glue reference signals 225 via the second control signaling 240 and trigger the transmission of such glue reference signals 225 via the control information 210 scheduling the shared channels 220.

Additionally, in some aspects, the wireless device 205-a may indicate locations (in time) of one or more phase jump boundaries 230 via the control information 210-b. That is, the wireless device 205-a may dynamically determine, prior to scheduling the shared channels 220, such as the shared channels 220-c and 220-d, the location (in time) of one or more phase jump boundaries 230 within a slot 206 or across the slots 206-c and 205-d. In such aspects, the wireless device 205-a may dynamically determine the phase jump boundary 230, such that the wireless device 205-a may dynamically indicate the presence and location (in time) of the phase jump boundary 230 to the wireless device 205-b via the control information 210-b.

As such, if the presence and location of the phase jump boundary 230 is dynamically indicated via the control information 210-b, the wireless device 205-a may also dynamically indicate the transmission (e.g., presence of) and time location (e.g., symbols 208) of the glue reference signal 225-c via the control information 210-b. In such aspects, to indicate the symbols of the glue reference signal 225-c, the wireless device 205-a may indicate one or more symbol offsets via the control information 210-b, such that the wireless device 205-b may determine the one or more symbols 208 allocated for the glue reference signal 225-c from the one or more symbol offsets. In such aspects, the wireless device 205-b may utilize the symbol 208 used to receive the control information 210-b as a reference symbol 208 for the one or more symbol offsets (e.g., the symbol offsets indicate a symbol 208 from the reception of the control information 210-b).

In some aspects, the wireless device 205-a may transmit separate control information 210 (e.g., DCI, UCI, or SCI) indicating the presence of the glue reference signal 225-c (e.g., triggering the glue reference signal 225-c) and indicating the one or more symbol offsets. That is, the wireless device 205-a may transmit control information 210 (e.g., second control information) prior to the control information 210-b triggering the transmission of the glue reference signal 225-c. As such, the wireless device 205-a may also transmit control information 210-b indicating the one or more symbol offsets associated with the symbols 208 for reception of the glue reference signal 225-c, where such symbol offsets are from the reception of the control information 210-b or from the reception of the prior control information 210.

In some other aspects, the wireless device 205-a may transmit control signaling (e.g., phase jump boundary signaling, RRC signaling, layer 2 signaling) prior to the control information 210-b, where the control signaling indicates one or more symbol offsets (from the control signaling or the control information 210-b) associated with the phase jump boundary 230. In such aspects, the wireless device 205-b may implicitly derive the symbols associated with the glue reference signal 225-c from the control signaling. That is, the wireless device 205-b may first identify the symbols 208 associated with the phase jump boundary 230 indicated from the control signaling. In response to identifying the symbols associated with the phase jump boundary 230, the wireless device 205-b may implicitly determine that at least a symbol 208 prior to those identified for the phase jump boundary 230, at least a symbol 208 after those identified for the phase jump boundary 230, or both include the glue reference signal 225-c.

In some aspects, the wireless device 205-a may configure various parameters associated with the glue reference signal 225, such as frequency density, time density, among others, via RRC signaling. As such, the wireless device 205-b may, in response to receiving the trigger for the glue reference signals 225, monitor for and receive the glue reference signals using the configured parameters.

In some aspects, such as dynamically triggering glue reference signals 225 across multiple slots 206, the wireless device 205-a may trigger the respective glue reference signals 225 in the associated slots 206. That is, the wireless device 205-a may trigger the glue reference signal 225-c in the slot 206-c (e.g., associated SLIV) via the control information 210-b, where the control information 210-b schedules the shared channel 220-c for the slot 206-c. In such aspects, the trigger of the transmission of the glue reference signal 225-c is included in the control information 210-b that schedules the slot 206-c.

Similarly, in such aspects, to schedule a fourth glue reference signal 225 in the slot 206-d, the wireless device 205-a may transmit fourth control information 210 scheduling the shared channel 220-d in the slot 206-d and also schedule the transmission of the fourth glue reference signal 225 in a symbol 208 of the slot 206-d.

Alternatively, the wireless device 205-a may trigger the transmission of glue reference signals 225 across multiple slots 206, such as the slot 206-c and the slot 206-d via the control information 210-b. That is, the wireless device 205-a may support cross-SLIV triggering of glue reference signals 225, where the wireless device 205-a may trigger the transmission of glue reference signals 225 in a first slot 206 via control information 210 that is associated with a previous slot 206. As an illustrative aspect, the wireless device 205-a may trigger a fourth glue reference signal 225 for the slot 206-d via the control information 210-b, while the glue reference signal 225-c may be triggered, scheduled, or both from control information scheduling a slot 206 previous to the slot 206-c.

In such aspects of cross SLIV triggering, the wireless device 205-a may indicate one or more timing offsets associated with the glue reference signal 225. In one aspect, the wireless device 205 may indicate, via the control information 210 triggering the glue reference signal 225, an absolute timing offset from reception of the control information 210. Alternatively, in another aspect, the wireless device 205 may indicate, via the control information 210 triggering the glue reference signal 225, a slot offset, one or more symbol offsets, or both. In such aspects, the slot offset may be with respect to the slot 206 associated with the control information 210 scheduling the glue reference signal 225 or may be with respect to the slot 206 in which the glue reference signal 225 is transmitted. Similarly, the symbol offsets may be with respect to the slot 206 in which the control information 210 is transmitted or may be with respect to the slot 206 in which the glue reference signal 225 is transmitted.

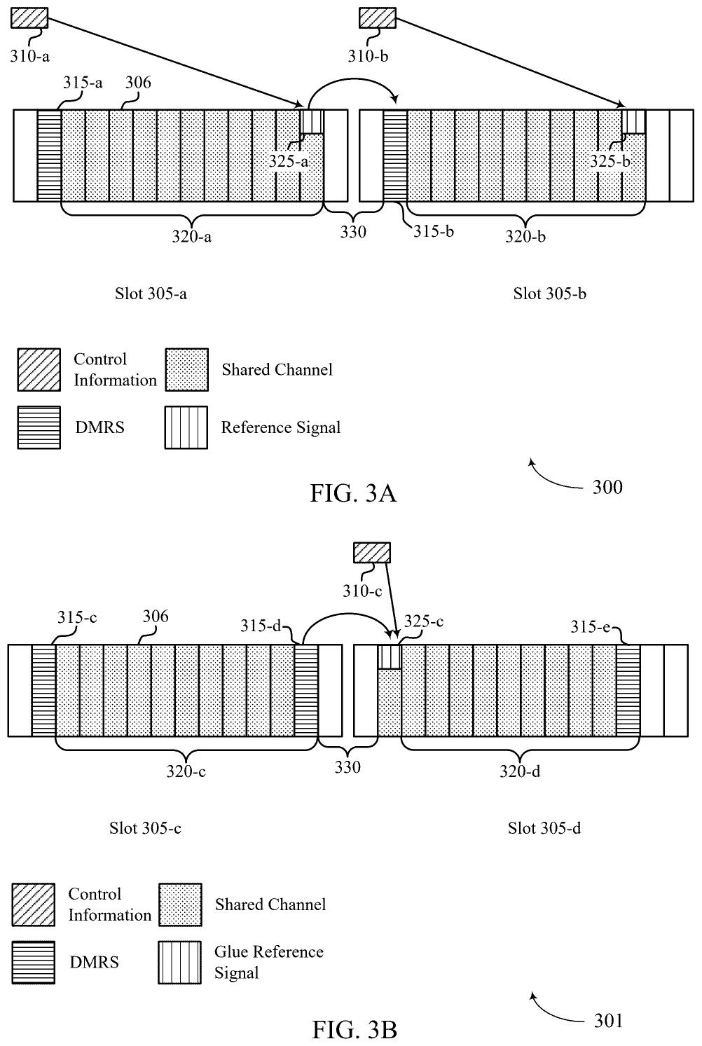

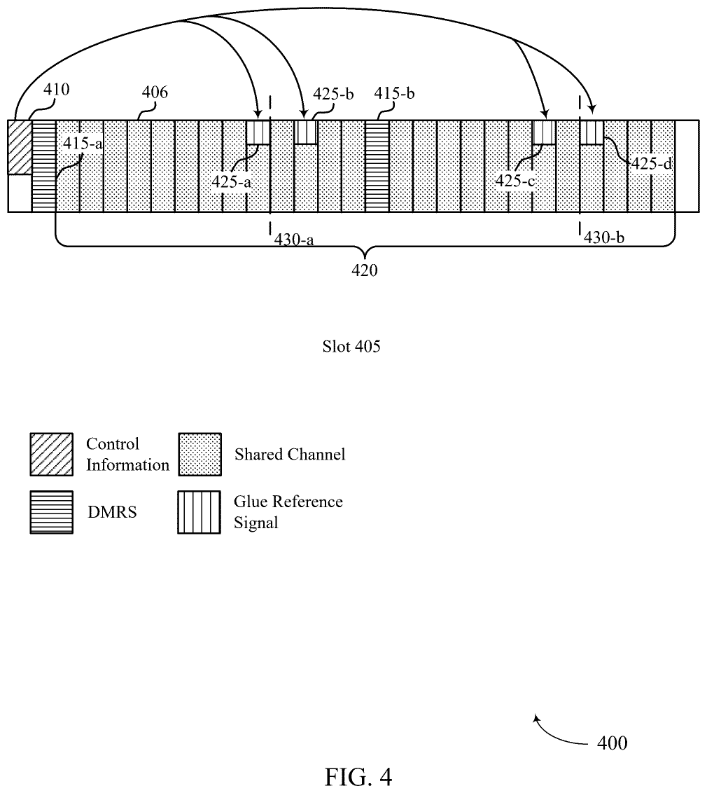

As described herein, the wireless devices 205 may support the dynamic trigger of the glue reference signal 225 in case of DMRS sharing across multiple SLIVs, which may be further described herein with reference to FIGS. 3A and 3B. Similarly, the wireless devices 205 may support the dynamic trigger of the glue reference signals 225 in the case of fluid SLIV allocations, which may be further described herein with reference to FIG. 4. By implementing such dynamic allocation and triggers, the wireless devices may observe a reduction in signaling overhead during communication of the shared channels 220, while also maintaining phase continuity.

FIGS. 3A and 3B show aspects of a resource diagram 300 and a resource diagram 301, respectively, that support dynamic reference signal signaling in accordance with one or more aspects of the present disclosure. Aspects of the resource diagram 300 and the resource diagram 301 may be implemented by the wireless communications system 100 and the wireless communications system 200, as described herein. In some cases, the resource diagram 300 and the resource diagram 301 may be implemented by wireless devices, such as the wireless devices 205.

As described herein, a first wireless device (e.g., transmitting wireless device, wireless device 205-a) may utilize dynamic glue reference signal signaling to reduce signaling overhead within slots 305. As such, based on whether the first wireless device is to transmit the glue reference signals 325 prior to, or after, the phase jump boundary 330, the first wireless device may utilize either non-causal glue reference signal triggering or causal glue reference signal triggering.

The techniques described in the context of the resource diagram 300 may enable the first wireless device (e.g., transmitting wireless device) to perform non-causal triggering of the glue reference signals 325-a and 325-b. The resource diagram 300 may illustrate two slots 305, a slot 305-a and a slot 305-b, where each slot 305 includes one or more symbols 306 allocated for the shared channels 320-a and 320-b (e.g., PUSCH, PDSCH, PSSCH), respectively. The resource diagram 300 may illustrate a front-loaded DMRS pattern, where each slot 305 may have include a symbol 306 allocated for the transmission of a DMRS 315. That is, the slot 305-a may have a symbol 306 allocated for the DMRS 315-a, while the slot 305-b may have a symbol allocated for the DMRS 315-b. As described herein, a second wireless device (e.g., receiving wireless device) may perform DMRS combining using the DMRSs 315-a and 315-b, such that the second wireless device may receive and decode the shared channel 220-a.

In some aspects, the first wireless device may determine whether to transmit the glue reference signal 325-a via a symbol 306 at an end of the slot 305-a (e.g., before the ending gap between the slot 305-a and the slot 305-b) by predicting whether there is an upcoming shared channel 220 (e.g., the shared channel 320-b) for DMRS combining, whether there is a phase jump boundary 330 between the two slots 305, or both. That is, the first wireless device may predict, prior to transmitting the control information 310-a (e.g., DCI, UCI, SCI) scheduling the shared channel 320-a, whether the shared channel 320-b and DMRS 315-b are to be scheduled in the slot 305-b, whether the DMRS 315-b is to be used for DMRS combining with the DMRS 315-a, and whether a phase jump boundary 330 is to occur between the slot 305-a and the slot 305-b.

As such, if the first wireless device determines that the shared channel 320-b is to be scheduled, the first wireless device may transmit the control information 310-a scheduling the shared channel 320-a and also triggering the transmission of the glue reference signal 325-a. The first wireless device may also indicate which symbol within the slot 305-a the glue reference signal is to be transmitted in using the techniques described herein with reference to FIG. 2 (e.g., using symbol offsets). In such aspects, the first wireless device may transmit the control information 310-a after a preceding slot and within a first symbol 306 of the slot 305-a. In this way, the receiving wireless device may receive the glue reference signal 325-a and perform first phase estimations (e.g., measurements), receive the DMRS 315-b and perform second phase estimations, and use both the first and second phase estimations to identify the phase jump (e.g., phase change) across the phase jump boundary 330.

Similarly, to schedule the glue reference signal 325-b, the first wireless device may predict, prior to transmitting the control information 310-b (e.g., DCI, UCI, SCI) scheduling the shared channel 320-b, whether a third shared channel 320 and third DMRS 315 (not shown) are to be scheduled in a third slot 305, whether the third DMRS 315 is to be used for DMRS combining with the DMRS 315-b, and whether a phase jump boundary 330 is to occur between the slot 305-b and the third slot. Based on the prediction, the first wireless device may transmit the control information 310-b scheduling the shared channel 320-b and also triggering the transmission of the glue reference signal 325-b.

The techniques described in the context of the resource diagram 301 may enable the first wireless device (e.g., transmitting wireless device) to perform causal triggering of the glue reference signal 325-c. The resource diagram 301 may illustrate two slots 305, a slot 305-c and a slot 305-d, where each slot 305 includes one or more symbols 306 allocated for the shared channels 320-c and 320-d (e.g., PUSCH, PDSCH, PSSCH), respectively. The resource diagram 301 may illustrate a rear-loaded DMRS pattern, where each slot 305 may have include one or more symbols 306 allocated for the transmission of a DMRS 315. That is, the slot 305-c may have a first symbol 306 allocated for the DMRS 315-c and a second symbol 306 allocated for the DMRS 315-d (e.g., rear DMRS), while the slot 305-d may have a symbol allocated for the DMRS 315-e. As described herein, a second wireless device (e.g., receiving wireless device) may perform DMRS combining using the DMRSs 315-c, 315-d, and 315-e, such that the second wireless device may receive and decode the shared channels 320-c and 320-d.

In some aspects, the first wireless device may determine whether to transmit the glue reference signal 325-c at a beginning of the slot 305-d (e.g., after the phase jump boundary 330) based on whether the prior shared channel 320-c was used for DMRS combining and whether a phase jump boundary 330 occurred between the slot 305-c and a third slot 305 previous to the slot 305-c. That is, the first wireless device may determine to transmit the glue reference signal 325-c after the phase jump boundary 330 and at the beginning of the slot 305-d based on whether DMRS combining for shared channels 320 occurred between two previous slots 305 and whether a phase jump boundary 330 occurred between the two previous slots 305.

As such, if the first wireless device determines that DMRS combining and the phase jump boundary 330 occurred between two slots 305 prior to the slot 305-d, the first wireless device may transmit control information 310-c (e.g., DCI, UCI, or SCI) triggering the glue reference signal 325-c. In such aspects, the first wireless device may also indicate which symbol within the slot 305-d the glue reference signal 325-c is to be transmitted in using the techniques described herein with reference to FIG. 2 (e.g., using symbol offsets). In this way, the second wireless device may perform first phase estimations using the DMRS 315-d and perform second phase estimations using the glue reference signal 325-c and determine the phase change across the boundary 330 using the first and second phase estimations.

FIG. 4 shows an aspect of a resource diagram 400 that supports dynamic reference signal signaling in accordance with one or more aspects of the present disclosure. Aspects of the resource diagram 400 may be implemented by aspects of the wireless communications system 100 and the wireless communications system 200, as described herein. In some aspects, the resource diagram 400 may be implemented by wireless devices, such as the wireless devices 205 as described herein with reference to FIG. 2. The techniques described in the context of the resource diagram 400 may enable a first wireless device (e.g., transmitting device) to trigger glue reference signals 425 in fluid SLIV allocations (e.g., in a slot 405 scheduled with more than 14 symbols 406).

As described herein, wireless devices may implement a fluid SLIV design, such that the wireless devices may communicate via the slot 405 that has more than 14 symbols 406. Additionally, to support the slot 405 with an increased quantity of symbols 406, DMRSs 415 may be uniformly distributed throughout the slot 405. That is, the first wireless device may transmit one or more DMRSs 415, such as the DMRS 415-a and the DMRS 415-b uniformly throughout the slot 405, such that the second wireless device may utilize the DMRSs to perform channel estimation.

As illustrated, in a fluid SLIV design, the wireless devices may experience multiple phase discontinuities (e.g., phase jump boundaries 430-a and 430-b) within the slot 405 (e.g., long SLIV), which may lead to the first wireless device triggering multiple glue reference signals 425, such as the glue reference signal 425-a, the glue reference signal 425-b, the glue reference signal 425-c, and the glue reference signal 425-d, within the slot 405.

To facilitate such communications, the first wireless device may trigger the transmission of the glue reference signals 425 via the control information 410 (e.g., DCI, UCI, SCI) that schedules the shared channel 420 (e.g., PDSCH, PUSCH, PSSCH). As an illustrative aspect, if the shared channel 420 is a PDSCH, the first wireless device may trigger the transmission of the glue reference signals 425 in the DCI that schedules the PDSCH and that is before the PDSCH burst. In such aspects, the first wireless device may trigger such glue reference signals 425 non-causally, as described herein with reference to FIG. 3, because the first wireless device may predict whether the phase jump boundaries 430-a and 430-b will occur within the slot 405.

In some aspects, the first wireless device may include the time domain locations (e.g., symbols 406) of the glue reference signals 425 via the control information 410. That is, the first wireless device may trigger and schedule the glue reference signals 425 via the control information 410, such that the second wireless device may identify the symbols 406 associated with each glue reference signal 425.

In one aspect, the first wireless device may explicitly signal the time domain locations of the glue reference signals 425 via the control information 410 by indicating one or more symbol offsets. As an illustrative aspect, the first wireless device may, via the control information 410, indicate a first symbol offset (e.g., 10 symbols 406) for the glue reference signal 425-a, indicate a second symbol offset (e.g., 12 symbols 406) for the glue reference signal 425-b, indicate a third symbol offset (e.g., 22 symbols 406) for the glue reference signal 425-c, and indicate a fourth symbol offset (e.g., 24 symbols 406) for the glue reference signal 425-d.

In another aspect, the first wireless device may configure, via RRC signaling, multiple time domain patterns (e.g., symbol patterns, each X symbols 406) associated with the glue reference signal (e.g., a table of time domain patterns). Accordingly, the first wireless device may signal, via the control information 410, an index to the multiple time domain patterns, such that the second wireless device may identify the symbols associated with each glue reference signal 425. In such aspects, each of the time domain patterns may include a respective symbol gap between two glue reference signals 425 (e.g., a quantity of symbols 406 between two glue reference signals 425), such that if the phase jump boundary 430 occurs between the symbol gap, the second wireless device may accurately measure the phase jump across the phase jump boundary 430. Such symbol gaps may reduce the overhead of glue reference signals 425 within the slot 405.

Based on receiving the control information 410, the second wireless device may estimate multiple phase jumps (e.g., changes) across the phase jump boundaries 430 within the slot 405. That is, the second wireless device may perform first phase estimations using the glue reference signal 425-a, perform second phase estimations using the glue reference signal 425-b, and estimate the phase jump across the phase jump boundary 430-a according to the first and second phase estimations. Similarly, the second wireless device may perform first phase estimations using the glue reference signal 425-c, perform second phase estimations using the glue reference signal 425-d, and estimate the phase jump across the phase jump boundary 430-b according to the first and second phase estimations.

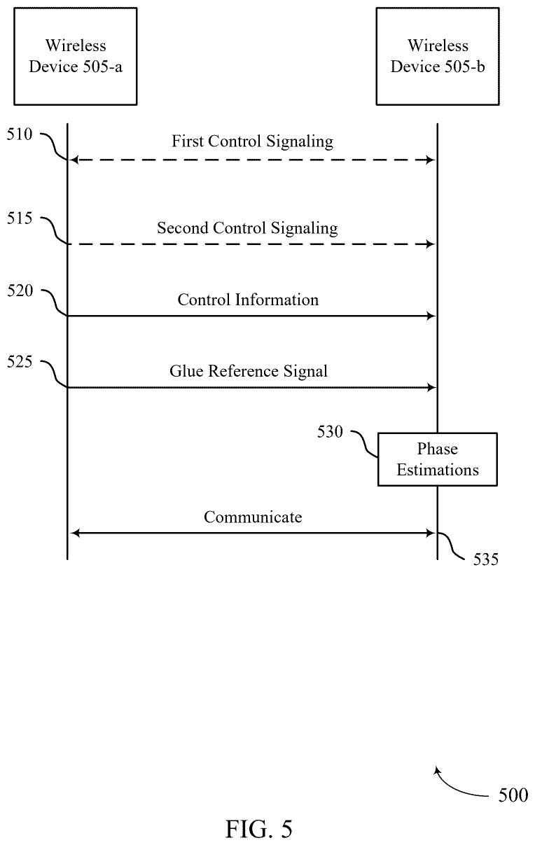

FIG. 5 shows an aspect of a process flow 500 that supports dynamic reference signal signaling in accordance with one or more aspects of the present disclosure. Aspects of the process flow 500 may implement, or be implemented by, aspects of the wireless communications system 100, the wireless communications system 200, the resource diagram 300, the resource diagram 301, and the resource diagram 400. In some aspects, the wireless devices 505 may be aspects of the wireless devices 205, as described herein with reference to FIG. 2. That is, the wireless device 505-a may be a network entity 105 or a UE 115, while the wireless device 505-b may be a network entity 105 or a UE 115. The techniques described in the context of the process flow 500 may enable the wireless devices to support dynamic indication and transmission of the glue reference signal.

At 510, the wireless device 505-a and the wireless device 505-b may communicate first control signaling (e.g., first control signaling 235, RRC signaling, layer 2 signaling) to identify one or more phase jump boundaries within a slot (e.g., a fluid SLIV, slot with greater than 14 symbols) or across multiple slots (e.g., across multiple SLIVs). The wireless devices 505 may identify such phase jump boundaries in accordance with the techniques described herein with reference to FIG. 2.

At 515, the wireless device 505-b may transmit second control signaling (e.g., second control signaling 240, RRC signaling, layer 2 signaling) allocating one or more symbols for reception of one or more glue reference signals (e.g., reference signal associated with phase measurement across the phase jump boundary), as described herein with reference to FIG. 2.

At 520, the wireless device 505-b may receive control information triggering the transmission of the one or more glue reference signals in one or more allocated symbols. In some aspects, the control information may also include an allocation of the one or more symbols, as described herein with reference to FIGS. 2 through 4. In some aspects, the control information may be DCI, where, in such aspects, the wireless device 505-a may be a network entity 105 and the wireless device 505-b may be a UE 115. Alternatively, the control information may be UCI, where, in such aspects, the wireless device 505-a, may be a UE 115 and the wireless device 505-b may be a network entity 105. In another aspect, the control information may be SCI, where, in such aspects, the wireless devices 505 may both UEs 115.

At 525, the wireless device 505-b may monitor the allocated symbols for the glue reference signal and receive the glue reference signal from the wireless device 505-a. At 530, the wireless device 505-b may perform phase estimations to identify potential phase changes across the phase jump boundary, as described herein with reference to FIGS. 2 and 4. At 535, the wireless devices 505 may communicate (e.g., via the shared channel) in accordance with performing the phase estimations.

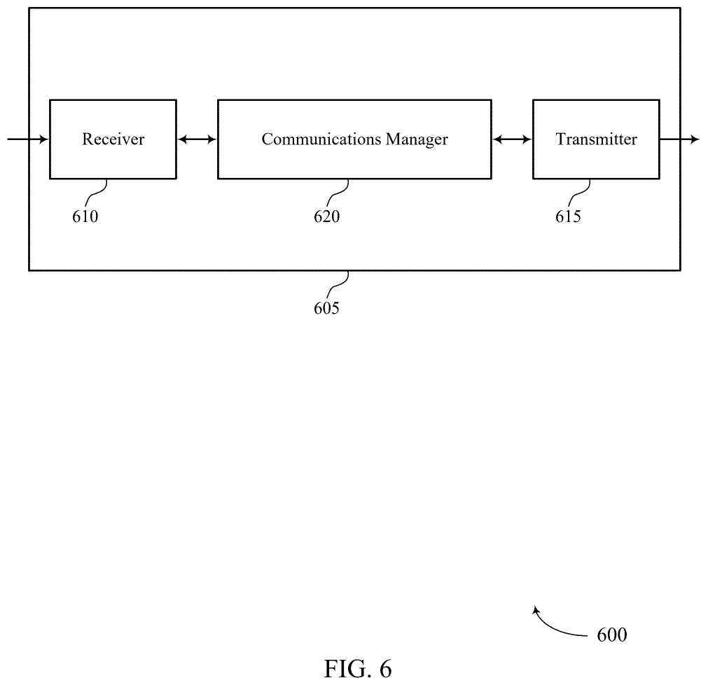

FIG. 6 shows a block diagram 600 of a device 605 that supports dynamic reference signal signaling in accordance with one or more aspects of the present disclosure. The device 605 may be an aspect a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to dynamic reference signal signaling). Information may be passed on to other components of the device 605. The receiver 610 may utilize a single antenna or a set of multiple antennas.

The transmitter 615 may provide a means for transmitting signals generated by other components of the device 605. In such aspects, the transmitter 615 may transmit information such as packets, user data, control information, or any combination thereof associated with various information channels (e.g., control channels, data channels, information channels related to dynamic reference signal signaling). In some aspects, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be aspects of means for performing various aspects of dynamic reference signal signaling as described herein. In such aspects, the communications manager 620, the receiver 610, the transmitter 615, or various combinations or components thereof may be capable of performing one or more of the functions described herein.

In some aspects, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 620 may be configured to perform various operations (e.g., receiving, obtaining, monitoring, outputting, transmitting) using or otherwise in cooperation with the receiver 610, the transmitter 615, or both. In such aspects, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications implemented in accordance with aspects as disclosed herein. In such aspects, the communications manager 620 is capable of, configured to, or operable to support a means for receiving, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The communications manager 620 is capable of, configured to, or operable to support a means for monitoring the one or more symbols for the reference signal in accordance with the control information. The communications manager 620 is capable of, configured to, or operable to support a means for performing the phase measurements associated with the phase jump boundary using the reference signal in accordance with the monitoring of the one or more symbols.

By including or configuring the communications manager 620 in accordance with aspects as described herein, the device 605 (e.g., at least one processor controlling or otherwise coupled with the receiver 610, the transmitter 615, the communications manager 620, or a combination thereof) may support techniques for more efficient utilization of communication resources.

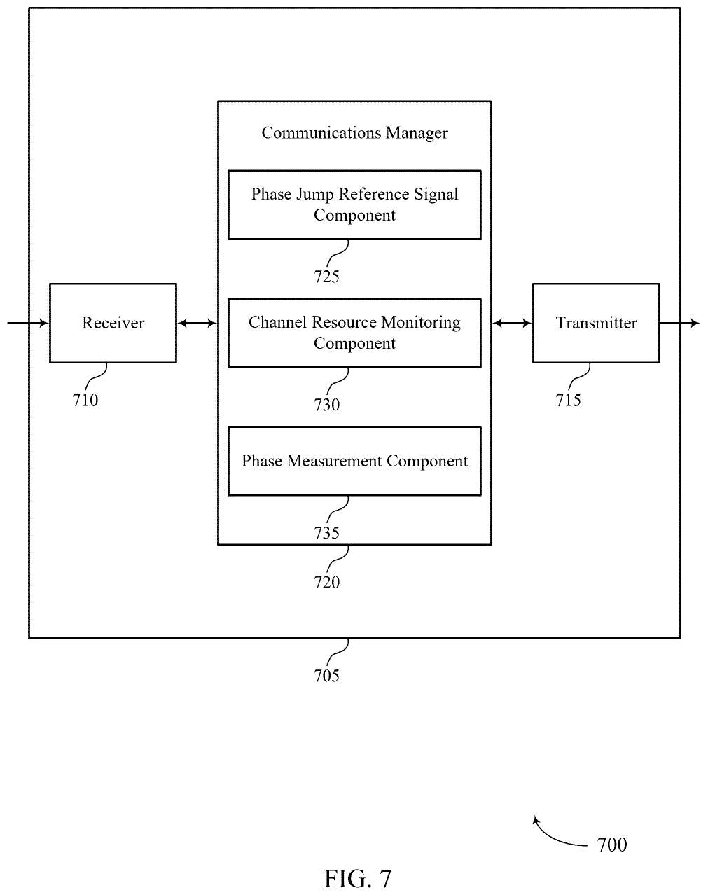

FIG. 7 shows a block diagram 700 of a device 705 that supports dynamic reference signal signaling in accordance with one or more aspects of the present disclosure. The device 705 may be an aspect of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to dynamic reference signal signaling). Information may be passed on to other components of the device 705. The receiver 710 may utilize a single antenna or a set of multiple antennas.

The transmitter 715 may provide a means for transmitting signals generated by other components of the device 705. In such aspects, the transmitter 715 may transmit information such as packets, user data, control information, or any combination thereof associated with various information channels (e.g., control channels, data channels, information channels related to dynamic reference signal signaling). In some aspects, the transmitter 715 may be co-located with a receiver 710 in a transceiver module. The transmitter 715 may utilize a single antenna or a set of multiple antennas.

The device 705, or various components thereof, may be include means for performing various aspects of dynamic reference signal signaling as described herein. In such aspects, the communications manager 720 may include a phase jump reference signal component 725, a channel resource monitoring component 730, a phase measurement component 735, or any combination thereof. The communications manager 720 may be an aspect of a communications manager 620 as described herein. In some aspects, the communications manager 720, or various components thereof, may be configured to perform various operations (e.g., receiving, obtaining, monitoring, outputting, transmitting) using or otherwise in cooperation with the receiver 710, the transmitter 715, or both. In such aspects, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications implemented in accordance with aspects as disclosed herein. The phase jump reference signal component 725 is capable of, configured to, or operable to support a means for receiving, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The channel resource monitoring component 730 is capable of, configured to, or operable to support a means for monitoring the one or more symbols for the reference signal in accordance with the control information. The phase measurement component 735 is capable of, configured to, or operable to support a means for performing the phase measurements associated with the phase jump boundary using the reference signal in accordance with the monitoring of the one or more symbols.

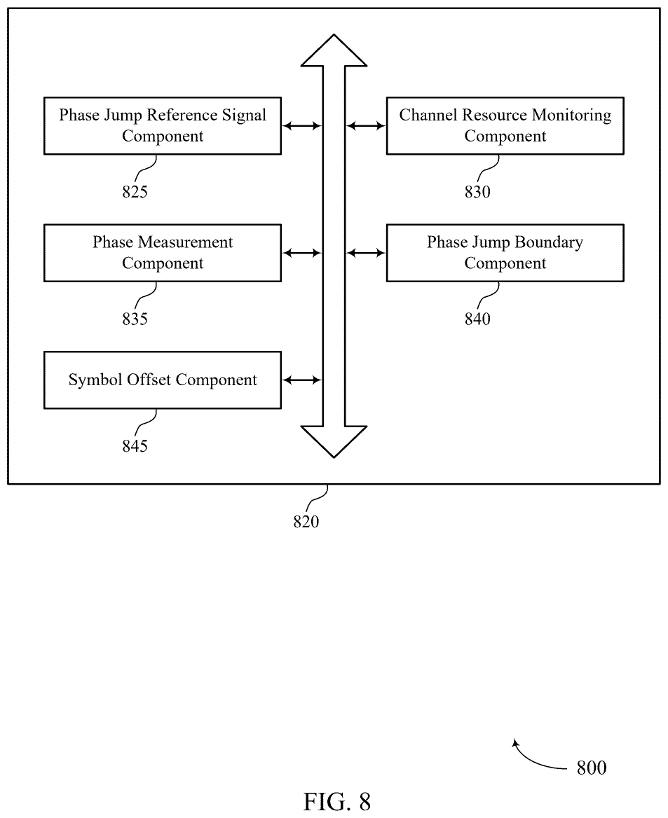

FIG. 8 shows a block diagram 800 of a communications manager 820 that supports dynamic reference signal signaling in accordance with one or more aspects of the present disclosure. The communications manager 820 may be an aspect of a communications manager 620, a communications manager 720, or both, as described herein. The communications manager 820, or various components thereof, may be means for performing various aspects of dynamic reference signal signaling as described herein. In such aspects, the communications manager 820 may include a phase jump reference signal component 825, a channel resource monitoring component 830, a phase measurement component 835, a phase jump boundary component 840, a symbol offset component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications implemented in accordance with aspects as disclosed herein. The phase jump reference signal component 825 is capable of, configured to, or operable to support a means for receiving, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The channel resource monitoring component 830 is capable of, configured to, or operable to support a means for monitoring the one or more symbols for the reference signal in accordance with the control information. The phase measurement component 835 is capable of, configured to, or operable to support a means for performing the phase measurements associated with the phase jump boundary using the reference signal in accordance with the monitoring of the one or more symbols.

In some aspects, the phase jump boundary component 840 is capable of, configured to, or operable to support a means for communicating, with the second wireless device, first control signaling to identify the phase jump boundary associated with the first slot, where the receiving of the control information is in accordance with the communicating of the first control signaling with the second wireless device.

In some aspects, the phase jump reference signal component 825 is capable of, configured to, or operable to support a means for receiving second control signaling allocating the one or more symbols in accordance with the identified phase jump boundary, where the receiving of the control information that triggers the transmission of the reference signal is in accordance with the second control signaling.

In some aspects, the control information further indicates one or more symbol offsets from a first symbol associated with reception of the control information, and each of the one or more symbols are identified in accordance with a respective symbol offset of the one or more symbol offsets.

In some aspects, the symbol offset component 845 is capable of, configured to, or operable to support a means for receiving second control information indicating one or more symbol offsets from a first symbol associated with reception of the second control information, where each of the one or more symbols are identified in accordance with a respective symbol offset of the one or more symbol offsets.

In some aspects, the phase jump reference signal component 825 is capable of, configured to, or operable to support a means for receiving RRC signaling indicating a frequency density associated with the reference signal, a time density associated with the reference signal, or both, where the monitoring for the reference signal is in accordance with the RRC signaling.

In some aspects, the reference signal is received in a symbol that precedes the phase jump boundary in accordance with a prediction that the phase jump boundary is to occur at an end of the first slot, in accordance with a prediction of DMRS combining between the first slot and the second slot after the first slot, or both.

In some aspects, the control information is received at a start of the first slot in accordance with the phase jump boundary being between the start of the first slot and an end of a second slot that precedes the first slot, in accordance with DMRS combining between the first slot and the second slot, or both.

In some aspects, the phase jump reference signal component 825 is capable of, configured to, or operable to support a means for receiving RRC signaling indicating a set of multiple time domain patterns associated with the transmission of the reference signal, where the control information includes an index indicating a first time domain pattern of the set of multiple time domain patterns, and where the one or more symbols are identified in accordance with the first time domain pattern.

In some aspects, the control information schedules a shared data channel in the first slot.

In some aspects, the control information schedules a first shared data channel in a second slot that precedes the first slot in time, and the one or more symbols for the transmission of the reference signal are associated with a second shared data channel in the first slot.

In some aspects, the control information indicates one or more time offsets from reception of the control information. In some aspects, each symbol of the one or more symbols is identified in accordance with a respective time offset of the one or more time offsets.

In some aspects, the control information indicates one or more slot offsets from the first slot, one or more symbol offsets from the first slot, or both. In some aspects, each symbol of the one or more symbols is identified in accordance with a respective slot offset of the one or more slot offsets, a respective symbol offset of the one or more symbol offsets, or both.

In some aspects, the first wireless device includes a UE and the second wireless device includes a network entity, the first wireless device includes the network entity and the second wireless device includes the UE, or the first wireless device includes a first UE and the second wireless device includes a second UE.

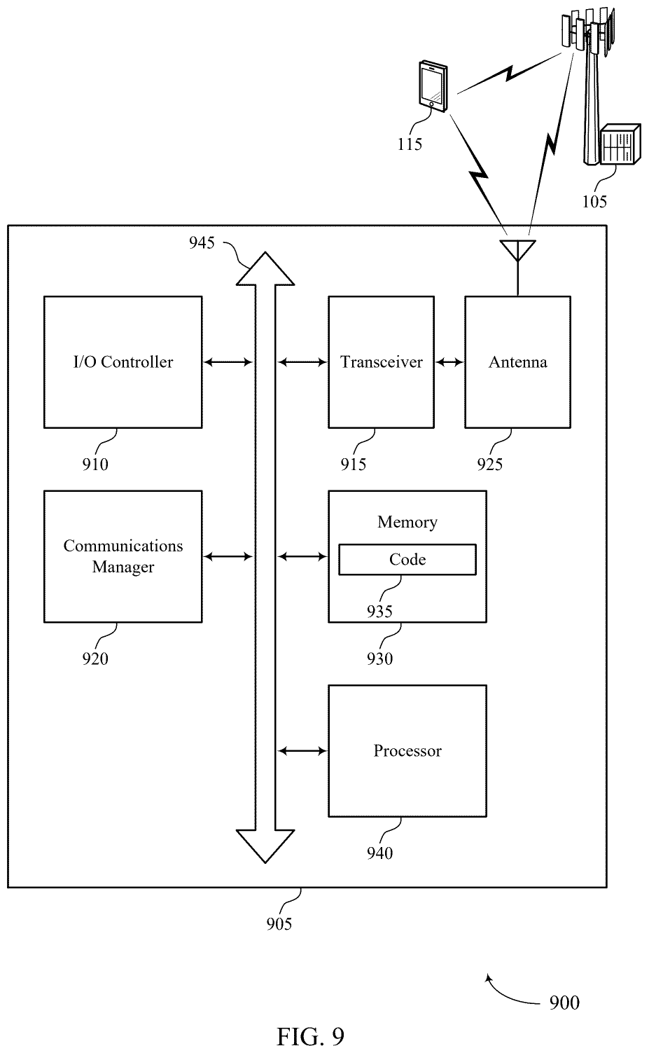

FIG. 9 shows a diagram of a system 900 including a device 905 that supports dynamic reference signal signaling in accordance with one or more aspects of the present disclosure. The device 905 may be an aspect of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. In such aspects, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an aspect of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting dynamic reference signal signaling). In such aspects, the device 905 or a component of the device 905 may include at least one processor 940 and at least one memory 930 coupled with or to the at least one processor 940, the at least one processor 940 and the at least one memory 930 configured to perform various functions described herein.

In some aspects, the at least one processor 940 may include multiple processors and the at least one memory 930 may include multiple memories. One or more of the multiple processors may be coupled with one or more of the multiple memories, which may, individually or collectively, be configured to perform various functions described herein. In some aspects, the at least one processor 940 may be a component of a processing system, which may refer to a system (such as a series) of machines, circuitry (including one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. In such aspects, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications implemented in accordance with aspects as disclosed herein. In such aspects, the communications manager 920 is capable of, configured to, or operable to support a means for receiving, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The communications manager 920 is capable of, configured to, or operable to support a means for monitoring the one or more symbols for the reference signal in accordance with the control information. The communications manager 920 is capable of, configured to, or operable to support a means for performing the phase measurements associated with the phase jump boundary using the reference signal in accordance with the monitoring of the one or more symbols.

By including or configuring the communications manager 920 in accordance with aspects as described herein, the device 905 may support techniques for improved communication reliability, more efficient utilization of communication resources, and improved coordination between devices.

In some aspects, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some aspects, one or more functions described with reference to the communications manager 920 may be supported by or performed by the at least one processor 940, the at least one memory 930, the code 935, or any combination thereof. In such aspects, the code 935 may include instructions executable by the at least one processor 940 to cause the device 905 to perform various aspects of dynamic reference signal signaling as described herein, or the at least one processor 940 and the at least one memory 930 may be otherwise configured to, individually or collectively, perform or support such operations.

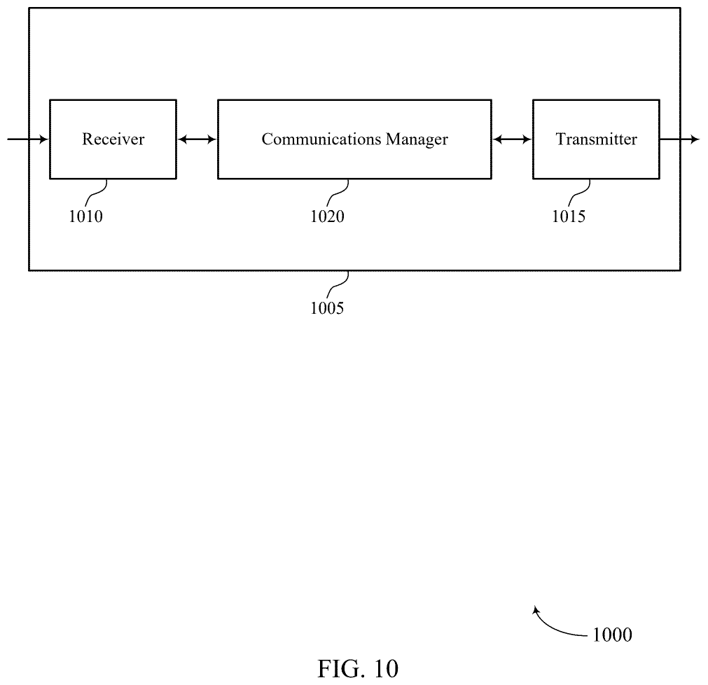

FIG. 10 shows a block diagram 1000 of a device 1005 that supports dynamic reference signal signaling in accordance with one or more aspects of the present disclosure. The device 1005 may be an aspect of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some aspects, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. In such aspects, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some aspects, the transmitter 1015 and the receiver 1010 may be co-located in a transceiver, which may include or be coupled with a modem.

The communications manager 1020, the receiver 1010, the transmitter 1015, or various combinations or components thereof may be aspects of means for performing various aspects of dynamic reference signal signaling as described herein. In such aspects, the communications manager 1020, the receiver 1010, the transmitter 1015, or various combinations or components thereof may be capable of performing one or more of the functions described herein.

In some aspects, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 1020 may be configured to perform various operations (e.g., receiving, obtaining, monitoring, outputting, transmitting) using or otherwise in cooperation with the receiver 1010, the transmitter 1015, or both. In such aspects, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications implemented in accordance with aspects as disclosed herein. In such aspects, the communications manager 1020 is capable of, configured to, or operable to support a means for transmitting, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The communications manager 1020 is capable of, configured to, or operable to support a means for transmitting, via the one or more symbols, the reference signal in accordance with the control information. The communications manager 1020 is capable of, configured to, or operable to support a means for communicating with the second wireless device in accordance with the transmitting of the reference signal via the one or more symbols and the phase measurements associated with the phase jump boundary.

By including or configuring the communications manager 1020 in accordance with aspects as described herein, the device 1005 (e.g., at least one processor controlling or otherwise coupled with the receiver 1010, the transmitter 1015, the communications manager 1020, or a combination thereof) may support techniques for more efficient utilization of communication resources.

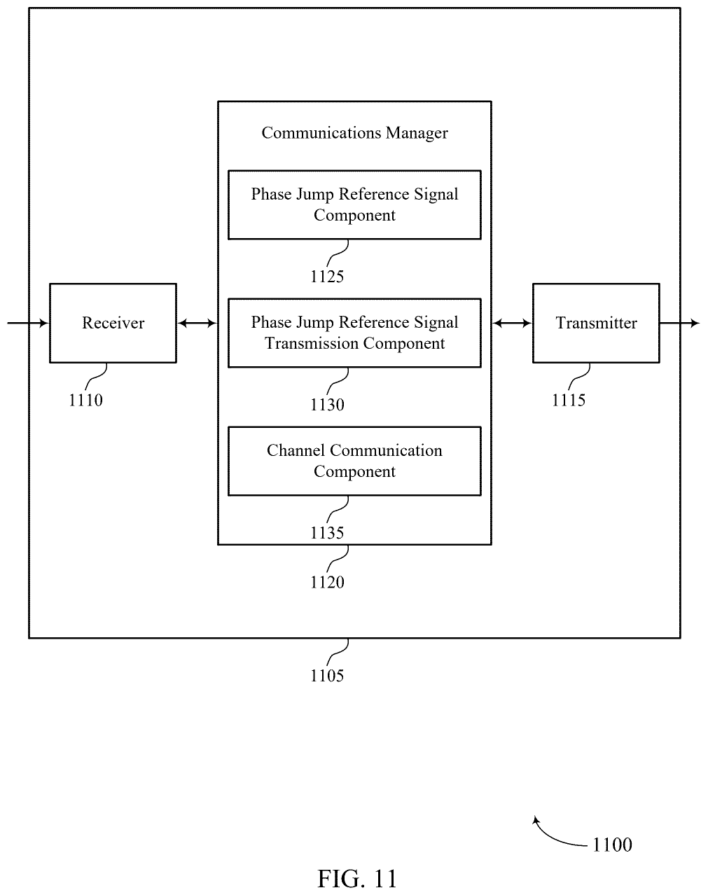

FIG. 11 shows a block diagram 1100 of a device 1105 that supports dynamic reference signal signaling in accordance with one or more aspects of the present disclosure. The device 1105 may be an aspect of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some aspects, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. In such aspects, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some aspects, the transmitter 1115 and the receiver 1110 may be co-located in a transceiver, which may include or be coupled with a modem.

The device 1105, or various components thereof, may be means for performing various aspects of dynamic reference signal signaling as described herein. In such aspects, the communications manager 1120 may include a phase jump reference signal component 1125, a phase jump reference signal transmission component 1130, a channel communication component 1135, or any combination thereof. The communications manager 1120 may be an aspect of a communications manager 1020 as described herein. In some aspects, the communications manager 1120, or various components thereof, may be configured to perform various operations (e.g., receiving, obtaining, monitoring, outputting, transmitting) using or otherwise in cooperation with the receiver 1110, the transmitter 1115, or both. In such aspects, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications implemented in accordance with aspects as disclosed herein. The phase jump reference signal component 1125 is capable of, configured to, or operable to support a means for transmitting, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The phase jump reference signal transmission component 1130 is capable of, configured to, or operable to support a means for transmitting, via the one or more symbols, the reference signal in accordance with the control information. The channel communication component 1135 is capable of, configured to, or operable to support a means for communicating with the second wireless device in accordance with the transmitting of the reference signal via the one or more symbols and the phase measurements associated with the phase jump boundary.

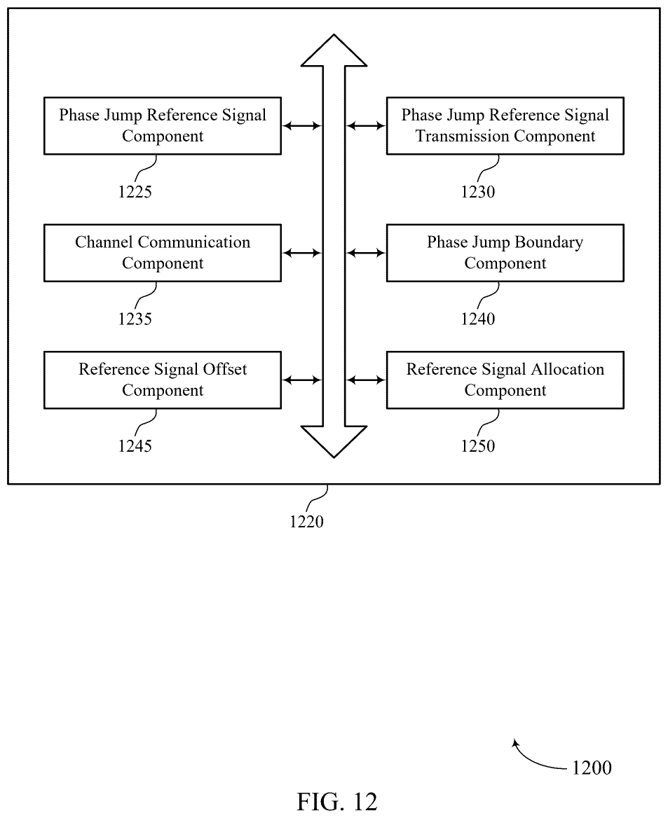

FIG. 12 shows a block diagram 1200 of a communications manager 1220 that supports dynamic reference signal signaling in accordance with one or more aspects of the present disclosure. The communications manager 1220 may be an aspect of a communications manager 1020, a communications manager 1120, or both, as described herein. The communications manager 1220, or various components thereof, may be means for performing various aspects of dynamic reference signal signaling as described herein. In such aspects, the communications manager 1220 may include a phase jump reference signal component 1225, a phase jump reference signal transmission component 1230, a channel communication component 1235, a phase jump boundary component 1240, a reference signal offset component 1245, a reference signal allocation component 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications implemented in accordance with aspects as disclosed herein. The phase jump reference signal component 1225 is capable of, configured to, or operable to support a means for transmitting, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The phase jump reference signal transmission component 1230 is capable of, configured to, or operable to support a means for transmitting, via the one or more symbols, the reference signal in accordance with the control information. The channel communication component 1235 is capable of, configured to, or operable to support a means for communicating with the second wireless device in accordance with the transmitting of the reference signal via the one or more symbols and the phase measurements associated with the phase jump boundary.

In some aspects, the phase jump boundary component 1240 is capable of, configured to, or operable to support a means for communicating, with the second wireless device, first control signaling to identify the phase jump boundary associated with the first slot, where the transmitting of the control information is in accordance with the communicating of the first control signaling with the second wireless device.

In some aspects, the reference signal allocation component 1250 is capable of, configured to, or operable to support a means for transmitting second control signaling allocating the one or more symbols in accordance with the identified phase jump boundary associated with the first slot, where the transmitting the control information triggering the transmission of the reference signal is in accordance with the second control signaling.

In some aspects, the control information further indicates one or more symbol offsets from a first symbol associated with the transmitting of the control information, and each of the one or more symbols are identified in accordance with a respective symbol offset of the one or more symbol offsets.

In some aspects, the reference signal offset component 1245 is capable of, configured to, or operable to support a means for transmitting second control information indicating one or more symbol offsets from a first symbol associated with the transmitting of the second control information, where each symbol of the one or more symbols is identified in accordance with a respective symbol offset of the one or more symbol offsets.

In some aspects, the reference signal allocation component 1250 is capable of, configured to, or operable to support a means for transmitting RRC signaling indicating a frequency density associated with the reference signal, a time density associated with the reference signal, or both, where the transmitting of the reference signal is in accordance with receiving the RRC signaling.

In some aspects, the reference signal is transmitted in a symbol that precedes the phase jump boundary in accordance with a prediction that the phase jump boundary is to occur at an end of the first slot, in accordance with a prediction of DMRS combining between the first slot and the second slot after the first slot, or both.

In some aspects, the control information is transmitted at a start of the first slot in accordance with the phase jump boundary being between the start of the first slot and an end of a second slot that precedes the first slot, in accordance with DMRS combining between the first slot and the second slot, or both.

In some aspects, the reference signal allocation component 1250 is capable of, configured to, or operable to support a means for transmitting RRC signaling indicating a set of multiple time domain patterns associated with the transmission of the reference signal, where the control information includes an index indicating a first time domain pattern of the set of multiple time domain patterns, and where the one or more symbols are identified in accordance with the first time domain pattern.

In some aspects, the control information schedules a shared data channel in the first slot.

In some aspects, the control information schedules a first shared data channel in a slot that precedes the first slot in time, and the one or more symbols for the transmission of the reference signal are associated with a second shared data channel in the first slot.

In some aspects, the control information indicates one or more time offsets from reception of the control information. In some aspects, each symbol of the one or more symbols are identified in accordance with a respective time offset of the one or more time offsets.

In some aspects, the control information indicates one or more slot offsets from the first slot, one or more symbol offsets from the first slot, or both. In some aspects, each symbol of the one or more symbols are identified in accordance with a respective slot offset of the one or more slot offsets, a respective symbol offset of the one or more symbol offsets, or both.

In some aspects, the first wireless device includes a UE and the second wireless device includes a network entity, the first wireless device includes the network entity and the second wireless device includes the UE, or the first wireless device includes a first UE and the second wireless device includes a second UE.

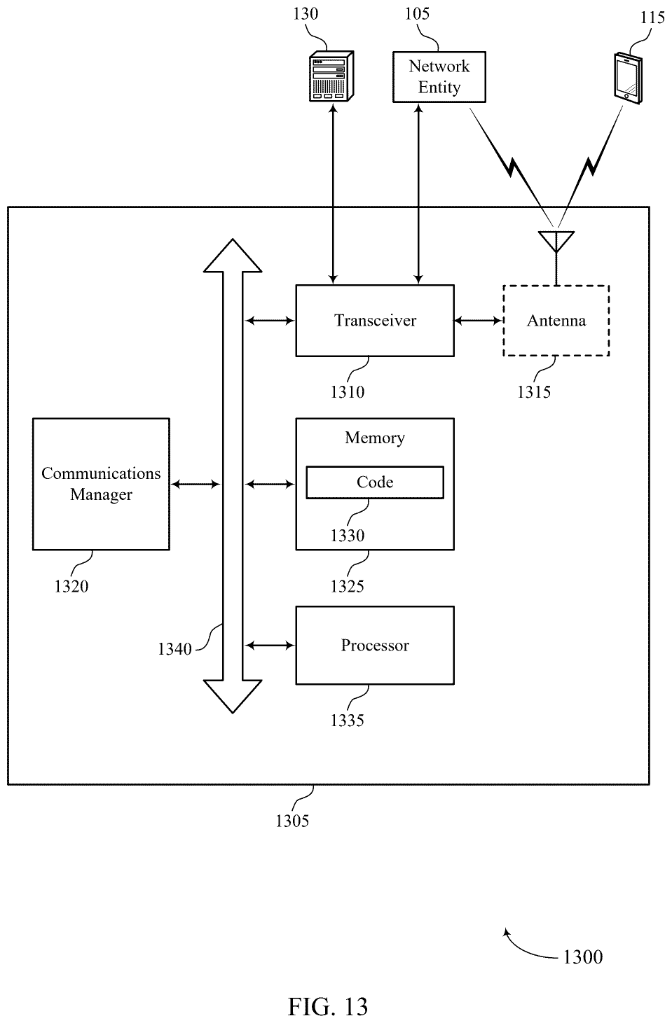

FIG. 13 shows a diagram of a system 1300 including a device 1305 that supports dynamic reference signal signaling in accordance with one or more aspects of the present disclosure. The device 1305 may be an aspect of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some aspects, the transceiver 1310 may include a wired transceiver and may communicate bi-directionally with another wired transceiver. Additionally, or alternatively, in some aspects, the transceiver 1310 may include a wireless transceiver and may communicate bi-directionally with another wireless transceiver. In some aspects, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some aspects, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some aspects, the at least one processor 1335 may include multiple processors and the at least one memory 1325 may include multiple memories. One or more of the multiple processors may be coupled with one or more of the multiple memories which may, individually or collectively, be configured to perform various functions herein (as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting dynamic reference signal signaling). In such aspects, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an aspect of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some aspects, the at least one processor 1335 may include multiple processors and the at least one memory 1325 may include multiple memories. One or more of the multiple processors may be coupled with one or more of the multiple memories, which may, individually or collectively, be configured to perform various functions herein. In some aspects, the at least one processor 1335 may be a component of a processing system, which may refer to a system (such as a series) of machines, circuitry (including one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. In such aspects, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some aspects, a bus 1340 may support communications of (e.g., within) a protocol layer of a protocol stack. In some aspects, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some aspects, the communications manager 1320 may manage aspects of communications with a core network 130 (e.g., via one or more wired or wireless backhaul links). In such aspects, the communications manager 1320 may manage the transfer of data communications for client devices, such as one or more UEs 115. In some aspects, the communications manager 1320 may manage communications with one or more other network entities 105, and may include a controller or scheduler for controlling communications with UEs 115 (e.g., in cooperation with the one or more other network devices). In some aspects, the communications manager 1320 may support an X2 interface within an LTE/LTE-A wireless communications network technology to provide communication between network entities 105.

The communications manager 1320 may support wireless communications implemented in accordance with aspects as disclosed herein. In such aspects, the communications manager 1320 is capable of, configured to, or operable to support a means for transmitting, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The communications manager 1320 is capable of, configured to, or operable to support a means for transmitting, via the one or more symbols, the reference signal in accordance with the control information. The communications manager 1320 is capable of, configured to, or operable to support a means for communicating with the second wireless device in accordance with the transmitting of the reference signal via the one or more symbols and the phase measurements associated with the phase jump boundary.

By including or configuring the communications manager 1320 in accordance with aspects as described herein, the device 1305 may support techniques for improved communication reliability, more efficient utilization of communication resources, and improved coordination between devices.

In some aspects, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some aspects, one or more functions described with reference to the communications manager 1320 may be supported by or performed by the transceiver 1310, one or more of the at least one processor 1335, one or more of the at least one memory 1325, the code 1330, or any combination thereof (by a processing system including at least a portion of the at least one processor 1335, the at least one memory 1325, the code 1330, or any combination thereof). In such aspects, the code 1330 may include instructions executable by one or more of the at least one processor 1335 to cause the device 1305 to perform various aspects of dynamic reference signal signaling as described herein, or the at least one processor 1335 and the at least one memory 1325 may be otherwise configured to, individually or collectively, perform or support such operations.

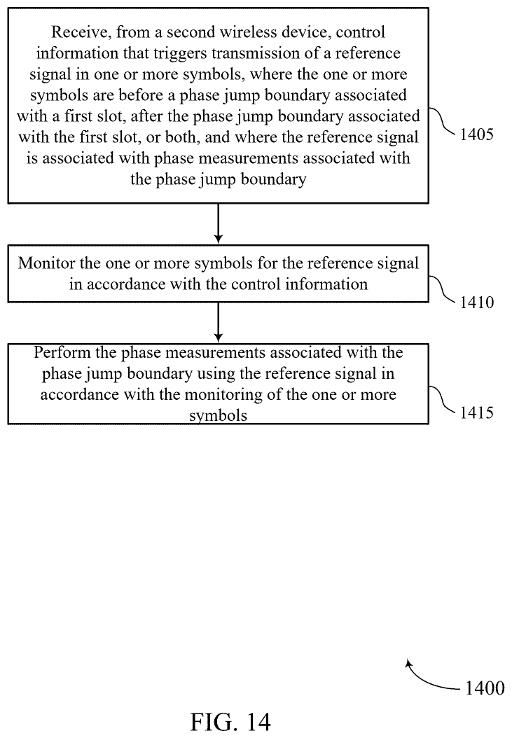

FIG. 14 shows a flowchart illustrating a method 1400 that supports dynamic reference signal signaling in accordance with one or more aspects of the present disclosure. The operations of the method 1400 may be implemented by a UE or its components as described herein. In such aspects, the operations of the method 1400 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1405, the method may include receiving, from a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The operations of 1405 may be performed in accordance with aspects as disclosed herein. Aspects of the operations of 1405 may be performed by a phase jump reference signal component 825 as described with reference to FIG. 8.

At 1410, the method may include monitoring the one or more symbols for the reference signal in accordance with the control information. The operations of 1410 may be performed in accordance with aspects as disclosed herein. Aspects of the operations of 1410 may be performed by a channel resource monitoring component 830 as described with reference to FIG. 8.

At 1415, the method may include performing the phase measurements associated with the phase jump boundary using the reference signal in accordance with the monitoring of the one or more symbols. The operations of 1415 may be performed in accordance with aspects as disclosed herein. Aspects of the operations of 1415 may be performed by a phase measurement component 835 as described with reference to FIG. 8.

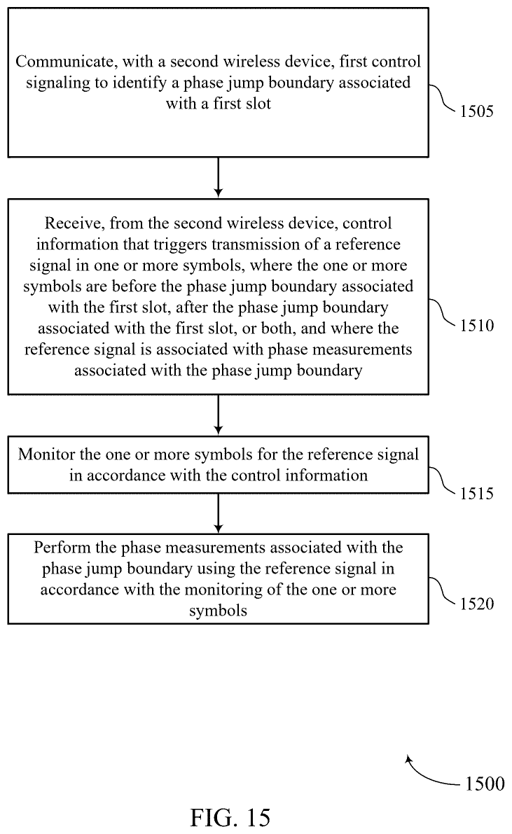

FIG. 15 shows a flowchart illustrating a method 1500 that supports dynamic reference signal signaling in accordance with one or more aspects of the present disclosure. The operations of the method 1500 may be implemented by a UE or its components as described herein. In such aspects, the operations of the method 1500 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1505, the method may include communicating, with a second wireless device, first control signaling to identify a phase jump boundary associated with a first slot. The operations of 1505 may be performed in accordance with aspects as disclosed herein. Aspects of the operations of 1505 may be performed by a phase jump boundary component 840 as described with reference to FIG. 8.

At 1510, the method may include receiving, from the second wireless device, control information that triggers transmission of a reference signal in one or more symbols, where the one or more symbols are before the phase jump boundary associated with the first slot, after the phase jump boundary associated with the first slot, or both, and where the reference signal is associated with phase measurements associated with the phase jump boundary. The operations of 1510 may be performed in accordance with aspects as disclosed herein. Aspects of the operations of 1510 may be performed by a phase jump reference signal component 825 as described with reference to FIG. 8.

At 1515, the method may include monitoring the one or more symbols for the reference signal in accordance with the control information. The operations of 1515 may be performed in accordance with aspects as disclosed herein. Aspects of the operations of 1515 may be performed by a channel resource monitoring component 830 as described with reference to FIG. 8.

At 1520, the method may include performing the phase measurements associated with the phase jump boundary using the reference signal in accordance with the monitoring of the one or more symbols. The operations of 1520 may be performed in accordance with aspects as disclosed herein. Aspects of the operations of 1520 may be performed by a phase measurement component 835 as described with reference to FIG. 8.

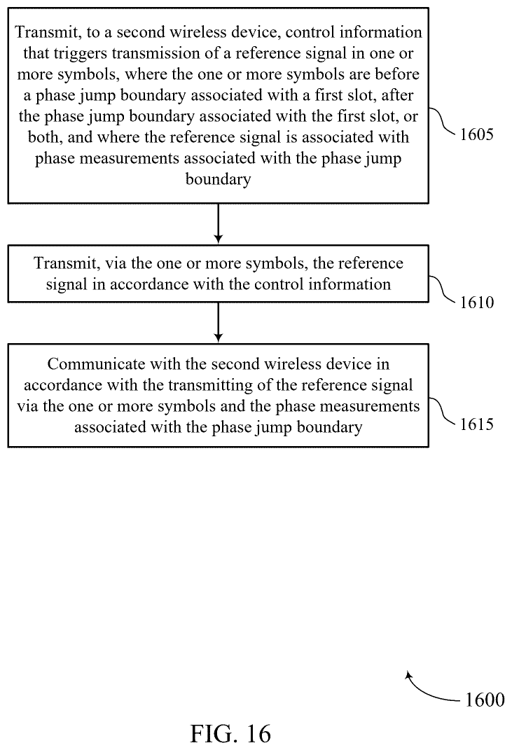

FIG. 16 shows a flowchart illustrating a method 1600 that supports dynamic reference signal signaling in accordance with one or more aspects of the present disclosure. The operations of the method 1600 may be implemented by a network entity or its components as described herein. In such aspects, the operations of the method 1600 may be performed by a network entity as described with reference to FIGS. 1 through 5 and 10 through 13. In some aspects, a network entity may execute a set of instructions to control the functional elements of the network entity to perform the described functions. Additionally, or alternatively, the network entity may perform aspects of the described functions using special-purpose hardware.

At 1605, the method may include transmitting, to a second wireless device, control information that triggers transmission of a reference signal in one or more symbols, where the one or more symbols are before a phase jump boundary associated with a first slot, after the phase jump boundary associated with the first slot, or both, and where the reference signal is associated with phase measurements associated with the phase jump boundary. The operations of 1605 may be performed in accordance with aspects as disclosed herein. Aspects of the operations of 1605 may be performed by a phase jump reference signal component 1225 as described with reference to FIG. 12.

At 1610, the method may include transmitting, via the one or more symbols, the reference signal in accordance with the control information. The operations of 1610 may be performed in accordance with aspects as disclosed herein. Aspects of the operations of 1610 may be performed by a phase jump reference signal transmission component 1230 as described with reference to FIG. 12.

At 1615, the method may include communicating with the second wireless device in accordance with the transmitting of the reference signal via the one or more symbols and the phase measurements associated with the phase jump boundary. The operations of 1615 may be performed in accordance with aspects as disclosed herein.

Aspects of the operations of 1615 may be performed by a channel communication component 1235 as described with reference to FIG. 12.

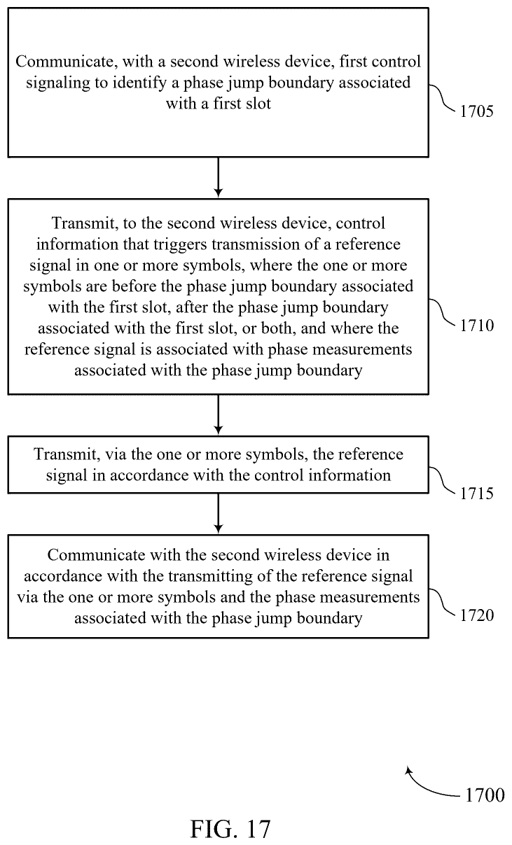

FIG. 17 shows a flowchart illustrating a method 1700 that supports dynamic reference signal signaling in accordance with one or more aspects of the present disclosure. The operations of the method 1700 may be implemented by a network entity or its components as described herein. In such aspects, the operations of the method 1700 may be performed by a network entity as described with reference to FIGS. 1 through 5 and 10 through 13. In some aspects, a network entity may execute a set of instructions to control the functional elements of the network entity to perform the described functions. Additionally, or alternatively, the network entity may perform aspects of the described functions using special-purpose hardware.

At 1705, the method may include communicating, with a second wireless device, first control signaling to identify a phase jump boundary associated with the first slot. The operations of 1705 may be performed in accordance with aspects as disclosed herein. Aspects of the operations of 1705 may be performed by a phase jump boundary component 1240 as described with reference to FIG. 12.

At 1710, the method may include transmitting, to the second wireless device, control information that triggers transmission of a reference signal in one or more symbols, where the one or more symbols are before the phase jump boundary associated with the first slot, after the phase jump boundary associated with the first slot, or both, and where the reference signal is associated with phase measurements associated with the phase jump boundary. The operations of 1710 may be performed in accordance with aspects as disclosed herein. Aspects of the operations of 1710 may be performed by a phase jump reference signal component 1225 as described with reference to FIG. 12.

At 1715, the method may include transmitting, via the one or more symbols, the reference signal in accordance with the control information. The operations of 1715 may be performed in accordance with aspects as disclosed herein. Aspects of the operations of 1715 may be performed by a phase jump reference signal transmission component 1230 as described with reference to FIG. 12.

At 1720, the method may include communicating with the second wireless device in accordance with the transmitting of the reference signal via the one or more symbols and the phase measurements associated with the phase jump boundary. The operations of 1720 may be performed in accordance with aspects as disclosed herein. Aspects of the operations of 1720 may be performed by a channel communication component 1235 as described with reference to FIG. 12.

The following provides an overview of aspects of the present disclosure:
Aspect 1: A method for wireless communications implemented by a first wireless device, comprising: receiving, from a second wireless device, control information that triggers transmission of a reference signal in one or more symbols, wherein the one or more symbols are before a phase jump boundary associated with a first slot, after the phase jump boundary associated with the first slot, or both, and wherein the reference signal is associated with phase measurements associated with the phase jump boundary; monitoring the one or more symbols for the reference signal in accordance with the control information; and performing the phase measurements associated with the phase jump boundary using the reference signal in accordance with the monitoring of the one or more symbols.
Aspect 2: The method of aspect 1, further comprising: communicating, with the second wireless device, first control signaling to identify the phase jump boundary associated with the first slot, wherein the receiving of the control information is in accordance with the communicating of the first control signaling with the second wireless device.
Aspect 3: The method of aspect 2, further comprising: receiving second control signaling allocating the one or more symbols in accordance with the identified phase jump boundary, wherein the receiving of the control information that triggers the transmission of the reference signal is in accordance with the second control signaling.
Aspect 4: The method of any of aspects 1 through 3, wherein the control information further indicates one or more symbol offsets from a first symbol associated with reception of the control information, and each of the one or more symbols are identified in accordance with a respective symbol offset of the one or more symbol offsets.
Aspect 5: The method of any of aspects 1 through 4, further comprising: receiving second control information indicating one or more symbol offsets from a first symbol associated with reception of the second control information, wherein each of the one or more symbols are identified in accordance with a respective symbol offset of the one or more symbol offsets.
Aspect 6: The method of any of aspects 1 through 5, further comprising: receiving RRC signaling indicating a frequency density associated with the reference signal, a time density associated with the reference signal, or both, wherein the monitoring for the reference signal is in accordance with the RRC signaling.
Aspect 7: The method of any of aspects 1 through 6, wherein the reference signal is received in a symbol that precedes the phase jump boundary in accordance with a prediction that the phase jump boundary is to occur at an end of the first slot, in accordance with a prediction of DMRS combining between the first slot and a second slot after the first slot, or both
Aspect 8: The method of any of aspects 1 through 7, wherein the control information is received at a start of the first slot in accordance with the phase jump boundary being between the start of the first slot and an end of a second slot that precedes the first slot, in accordance with DMRS combining between the first slot and the second slot, or both.
Aspect 9: The method of any of aspects 1 through 8, further comprising: receiving RRC signaling indicating a plurality of time domain patterns associated with the transmission of the reference signal, wherein the control information comprises an index indicating a first time domain pattern of the plurality of time domain patterns, and wherein the one or more symbols are identified in accordance with the first time domain pattern.
Aspect 10: The method of any of aspects 1 through 9, wherein the control information schedules a shared data channel in the first slot.
Aspect 11: The method of any of aspects 1 through 10, wherein the control information schedules a first shared data channel in a second slot that precedes the first slot in time, and the one or more symbols for the transmission of the reference signal are associated with a second shared data channel in the first slot.
Aspect 12: The method of aspect 11, wherein the control information indicates one or more time offsets from reception of the control information, and each symbol of the one or more symbols is identified in accordance with a respective time offset of the one or more time offsets.
Aspect 13: The method of any of aspects 11through 12, wherein the control information indicates one or more slot offsets from the first slot, one or more symbol offsets from the first slot, or both, and each symbol of the one or more symbols is identified in accordance with a respective slot offset of the one or more slot offsets, a respective symbol offset of the one or more symbol offsets, or both.
Aspect 14: The method of any of aspects 1 through 13, wherein the first wireless device comprises a UE and the second wireless device comprises a network entity, the first wireless device comprises the network entity and the second wireless device comprises the UE, or the first wireless device comprises a first UE and the second wireless device comprises a second UE.
Aspect 15: A method for wireless communications implemented by a first wireless device, comprising: transmitting, to a second wireless device, control information that triggers transmission of a reference signal in one or more symbols, wherein the one or more symbols are before a phase jump boundary associated with a first slot, after the phase jump boundary associated with the first slot, or both, and wherein the reference signal is associated with phase measurements associated with the phase jump boundary; transmitting, via the one or more symbols, the reference signal in accordance with the control information; and communicating with the second wireless device in accordance with the transmitting of the reference signal via the one or more symbols and the phase measurements associated with the phase jump boundary.
Aspect 16: The method of aspect 15, further comprising: communicating, with the second wireless device, first control signaling to identify the phase jump boundary associated with the first slot, wherein the transmitting of the control information is in accordance with the communicating of the first control signaling with the second wireless device.
Aspect 17: The method of aspect 16, further comprising: transmitting second control signaling allocating the one or more symbols in accordance with the identified phase jump boundary associated with the first slot, wherein the transmitting the control information triggering the transmission of the reference signal is in accordance with the second control signaling.
Aspect 18: The method of any of aspects 15 through 17, wherein the control information further indicates one or more symbol offsets from a first symbol associated with the transmitting of the control information, and each of the one or more symbols are identified in accordance with a respective symbol offset of the one or more symbol offsets.
Aspect 19: The method of any of aspects 15 through 18, further comprising: transmitting second control information indicating one or more symbol offsets from a first symbol associated with the transmitting of the second control information, wherein each symbol of the one or more symbols is identified in accordance with a respective symbol offset of the one or more symbol offsets.
Aspect 20: The method of any of aspects 15 through 19, further comprising: transmitting RRC signaling indicating a frequency density associated with the reference signal, a time density associated with the reference signal, or both, wherein the transmitting of the reference signal is in accordance with receiving the RRC signaling.
Aspect 21: The method of any of aspects 15 through 20, wherein the reference signal is transmitted in a symbol that precedes the phase jump boundary in accordance with a prediction that the phase jump boundary is to occur at an end of the first slot, in accordance with a prediction of DMRS combining between the first slot and a second slot after the first slot, or both
Aspect 22: The method of any of aspects 15 through 21, wherein the control information is transmitted at a start of the first slot in accordance with the phase jump boundary being between the start of the first slot and an end of a second slot that precedes the first slot, in accordance with DMRS combining between the first slot and the second slot, or both.
Aspect 23: The method of any of aspects 15 through 22, further comprising: transmitting RRC signaling indicating a plurality of time domain patterns associated with the transmission of the reference signal, wherein the control information comprises an index indicating a first time domain pattern of the plurality of time domain patterns, and wherein the one or more symbols are identified in accordance with the first time domain pattern.
Aspect 24: The method of any of aspects 15 through 23, wherein the control information schedules a shared data channel in the first slot.
Aspect 25: The method of any of aspects 15 through 24, wherein the control information schedules a first shared data channel in a slot that precedes the first slot in time, and the one or more symbols for the transmission of the reference signal are associated with a second shared data channel in the first slot.
Aspect 26: The method of any of aspects 15 through 25, wherein the control information indicates one or more time offsets from reception of the control information, and each symbol of the one or more symbols are identified in accordance with a respective time offset of the one or more time offsets.
Aspect 27: The method of any of aspects 15 through 26, wherein the control information indicates one or more slot offsets from the first slot, one or more symbol offsets from the first slot, or both, and each symbol of the one or more symbols are identified in accordance with a respective slot offset of the one or more slot offsets, a respective symbol offset of the one or more symbol offsets, or both.
Aspect 28: The method of any of aspects 15 through 27, wherein the first wireless device comprises a UE and the second wireless device comprises a network entity, the first wireless device comprises the network entity and the second wireless device comprises the UE, or the first wireless device comprises a first UE and the second wireless device comprises a second UE.
Aspect 29: A first wireless device for wireless communications implemented, comprising one or more memories storing processor-executable code, and one or more processors coupled with the one or more memories and individually or collectively operable to execute the code to cause the one or more processors to perform a method of any of aspects 1 through 14.
Aspect 30: A first wireless device for wireless communications implemented, comprising at least one means for performing a method of any of aspects 1 through 14.
Aspect 31: A non-transitory computer-readable medium storing code for wireless communications implemented, the code comprising instructions executable by one or more processors to perform a method of any of aspects 1 through 14.
Aspect 32: A first wireless device for wireless communications implemented, comprising one or more memories storing processor-executable code, and one or more processors coupled with the one or more memories and individually or collectively operable to execute the code to cause the one or more processors to perform a method of any of aspects 15 through 28.
Aspect 33: A first wireless device for wireless communications implemented, comprising at least one means for performing a method of any of aspects 15 through 28.
Aspect 34: A non-transitory computer-readable medium storing code for wireless communications implemented, the code comprising instructions executable by one or more processors to perform a method of any of aspects 15 through 28.

It should be noted that the methods described herein describe possible implementations. The operations and the steps may be rearranged, or otherwise modified and other implementations are possible. Further, aspects from two or more of the methods may be combined.

Although aspects of an LTE, LTE-A, LTE-A Pro, or NR system may be described for purposes of aspect, and LTE, LTE-A, LTE-A Pro, or NR terminology may be used in much of the description, the techniques described herein are applicable beyond LTE, LTE-A, LTE-A Pro, or NR networks. In such aspects, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. In such aspects, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other aspects and implementations are within the scope of the disclosure and appended claims. In such aspects, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of aspect, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. In such aspects, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that a list of at least one of A, B, or C means A or B or C or AB or AC or BC or ABC (i.e., A and B and C). Also, as used herein, the phrase “based on” shall not be construed as a reference to a closed set of conditions. In such aspects, an step that is described as “based on condition A” may be based on both a condition A and a condition B without departing from the scope of the present disclosure. In other words, as used herein, the phrase “based on” shall be construed in the same manner as the phrase “based at least in part on.”As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. In such aspects, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. In such aspects, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. In such aspects, referring to “the one or more components” subsequently in the claims may be understood to be equivalent to referring to “at least one of the one or more components.”The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes aspect configurations and does not represent all the aspects that may be implemented or that are within the scope of the claims. The term “aspect” used herein means “serving as an aspect, instance, or illustration” and not “preferred” or “advantageous over other aspects. ” The detailed description includes specific details for the purpose of providing an understanding of the described techniques. These techniques, however, may be practiced without these specific details. In some figures, known structures and devices are shown in block diagram form in order to avoid obscuring the concepts of the described aspects.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the aspects and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and operable to execute the code to cause the one or more processors, individually or collectively, to:
receive, from a second wireless device, control information that triggers transmission of a reference signal in one or more symbols, wherein the one or more symbols are before a phase jump boundary associated with a first slot, after the phase jump boundary associated with the first slot, or both, and wherein the reference signal is associated with phase measurements associated with the phase jump boundary;
monitor the one or more symbols for the reference signal in accordance with the control information; and
perform the phase measurements associated with the phase jump boundary using the reference signal in accordance with the monitoring of the one or more symbols.

2. The first wireless device of claim 1, wherein the one or more processors are further operable to execute the code to cause the one or more processors, individually or collectively, to:
communicate, with the second wireless device, first control signaling to identify the phase jump boundary associated with the first slot, wherein the receiving of the control information is in accordance with the communicating of the first control signaling with the second wireless device.

3. The first wireless device of claim 2, wherein the one or more processors are further operable to execute the code to cause the one or more processors, individually or collectively, to:
receive second control signaling allocating the one or more symbols in accordance with the identified phase jump boundary, wherein the receiving of the control information that triggers the transmission of the reference signal is in accordance with the second control signaling.

4. The first wireless device of claim 1, wherein the control information further indicates one or more symbol offsets from a first symbol associated with reception of the control information, and each of the one or more symbols are identified in accordance with a respective symbol offset of the one or more symbol offsets.

5. The first wireless device of claim 1, wherein the one or more processors are further operable to execute the code to cause the one or more processors, individually or collectively, to:
receive second control information indicating one or more symbol offsets from a first symbol associated with reception of the second control information, wherein each of the one or more symbols are identified in accordance with a respective symbol offset of the one or more symbol offsets.

6. The first wireless device of claim 1, wherein the one or more processors are further operable to execute the code to cause the one or more processors, individually or collectively, to:
receive radio resource control (RRC) signaling indicating a frequency density associated with the reference signal, a time density associated with the reference signal, or both, wherein the monitoring for the reference signal is in accordance with the RRC signaling.

7. The first wireless device of claim 1, wherein the reference signal is received in a symbol that precedes the phase jump boundary in accordance with a prediction that the phase jump boundary is to occur at an end of the first slot, in accordance with a prediction of demodulation reference signal (DMRS) combining between the first slot and a second slot after the first slot, or both.

8. The first wireless device of claim 1, wherein the control information is received at a start of the first slot in accordance with the phase jump boundary being between the start of the first slot and an end of a second slot that precedes the first slot, in accordance with demodulation reference signal (DMRS) combining between the first slot and the second slot, or both.

9. A first wireless device, comprising:
one or more memories storing processor-executable code; and
one or more processors coupled with the one or more memories and operable to execute the code to cause the one or more processors, individually or collectively, to:
transmit, to a second wireless device, control information that triggers transmission of a reference signal in one or more symbols, wherein the one or more symbols are before a phase jump boundary associated with a first slot, after the phase jump boundary associated with the first slot, or both, and wherein the reference signal is associated with phase measurements associated with the phase jump boundary;
transmit, via the one or more symbols, the reference signal in accordance with the control information; and
communicate with the second wireless device in accordance with the transmitting of the reference signal via the one or more symbols and the phase measurements associated with the phase jump boundary.

10. The first wireless device of claim 9, wherein the one or more processors are further operable to execute the code to cause the one or more processors, individually or collectively, to:
communicate, with the second wireless device, first control signaling to identify the phase jump boundary associated with the first slot, wherein the transmitting of the control information is in accordance with the communicating of the first control signaling with the second wireless device.

11. The first wireless device of claim 10, wherein the one or more processors are further operable to execute the code to cause the one or more processors, individually or collectively, to:
transmit second control signaling allocating the one or more symbols in accordance with the identified phase jump boundary associated with the first slot, wherein the transmitting the control information triggering the transmission of the reference signal is in accordance with the second control signaling.

12. The first wireless device of claim 9, wherein the control information further indicates one or more symbol offsets from a first symbol associated with the transmitting of the control information, and each of the one or more symbols are identified in accordance with a respective symbol offset of the one or more symbol offsets.

13. The first wireless device of claim 9, wherein the one or more processors are further operable to execute the code to cause the one or more processors, individually or collectively, to:
transmit second control information indicating one or more symbol offsets from a first symbol associated with the transmitting of the second control information, wherein each symbol of the one or more symbols is identified in accordance with a respective symbol offset of the one or more symbol offsets.

14. The first wireless device of claim 9, wherein the one or more processors are further operable to execute the code to cause the one or more processors, individually or collectively, to:
transmit radio resource control (RRC) signaling indicating a frequency density associated with the reference signal, a time density associated with the reference signal, or both, wherein the transmitting of the reference signal is in accordance with receiving the RRC signaling.

15. The first wireless device of claim 9, wherein the reference signal is transmitted in a symbol that precedes the phase jump boundary in accordance with a prediction that the phase jump boundary is to occur at an end of the first slot, in accordance with a prediction of demodulation reference signal (DMRS) combining between the first slot and a second slot after the first slot, or both.

16. The first wireless device of claim 9, wherein the control information is transmitted at a start of the first slot in accordance with the phase jump boundary being between the start of the first slot and an end of a second slot that precedes the first slot, in accordance with demodulation reference signal (DMRS) combining between the first slot and the second slot, or both.

17. A method for wireless communications implemented by a first wireless device, comprising:
receiving, from a second wireless device, control information that triggers transmission of a reference signal in one or more symbols, wherein the one or more symbols are before a phase jump boundary associated with a first slot, after the phase jump boundary associated with the first slot, or both, and wherein the reference signal is associated with phase measurements associated with the phase jump boundary;
monitoring the one or more symbols for the reference signal in accordance with the control information; and
performing the phase measurements associated with the phase jump boundary using the reference signal in accordance with the monitoring of the one or more symbols.

18. The method of claim 17, further comprising:
communicating, with the second wireless device, first control signaling to identify the phase jump boundary associated with the first slot; and
receiving second control signaling allocating the one or more symbols in accordance with the identified phase jump boundary, wherein the receiving of the control information that triggers the transmission of the reference signal is in accordance with the second control signaling.

19. The method of claim 17, further comprising:
receiving radio resource control (RRC) signaling indicating a plurality of time domain patterns associated with the transmission of the reference signal, wherein the control information comprises an index indicating a first time domain pattern of the plurality of time domain patterns, and wherein the one or more symbols are identified in accordance with the first time domain pattern.

20. The method of claim 17, wherein the control information schedules a shared data channel in the first slot.

21. The method of claim 17, wherein the control information schedules a first shared data channel in a second slot that precedes the first slot in time, and the one or more symbols for the transmission of the reference signal are associated with a second shared data channel in the first slot.

22. The method of claim 21, wherein the control information indicates one or more time offsets from reception of the control information, and wherein each symbol of the one or more symbols is identified in accordance with a respective time offset of the one or more time offsets.

23. The method of claim 21, wherein the control information indicates one or more slot offsets from the first slot, one or more symbol offsets from the first slot, or both, and wherein each symbol of the one or more symbols is identified in accordance with a respective slot offset of the one or more slot offsets, a respective symbol offset of the one or more symbol offsets, or both.

24. The method of claim 17, wherein the first wireless device comprises a user equipment (UE) and the second wireless device comprises a network entity, the first wireless device comprises the network entity and the second wireless device comprises the UE, or the first wireless device comprises a first UE and the second wireless device comprises a second UE.

25. A method for wireless communications implemented by a first wireless device, comprising:
transmitting, to a second wireless device, control information that triggers transmission of a reference signal in one or more symbols, wherein the one or more symbols are before a phase jump boundary associated with a first slot, after the phase jump boundary associated with the first slot, or both, and wherein the reference signal is associated with phase measurements associated with the phase jump boundary;
transmitting, via the one or more symbols, the reference signal in accordance with the control information; and
communicating with the second wireless device in accordance with the transmitting of the reference signal via the one or more symbols and the phase measurements associated with the phase jump boundary.

26. The method of claim 25, further comprising:
transmitting radio resource control (RRC) signaling indicating a plurality of time domain patterns associated with the transmission of the reference signal, wherein the control information comprises an index indicating a first time domain pattern of the plurality of time domain patterns, and wherein the one or more symbols are identified in accordance with the first time domain pattern.

27. The method of claim 25, wherein the control information schedules a shared data channel in the first slot.

28. The method of claim 25, wherein the control information schedules a first shared data channel in a slot that precedes the first slot in time, and the one or more symbols for the transmission of the reference signal are associated with a second shared data channel in the first slot.

29. The method of claim 25, wherein the control information indicates one or more time offsets from reception of the control information, and wherein each symbol of the one or more symbols are identified in accordance with a respective time offset of the one or more time offsets.

30. The method of claim 25, wherein the control information indicates one or more slot offsets from the first slot, one or more symbol offsets from the first slot, or both, and wherein each symbol of the one or more symbols are identified in accordance with a respective slot offset of the one or more slot offsets, a respective symbol offset of the one or more symbol offsets, or both.
